(19) United States
(12) Patent Application Publication
(10) Pub. No.: US 2015/0156226 A1
(43) Pub. Date: Jun. 4, 2015

(54) SYSTEM AND METHOD FOR INTERNET PUBLISHING

(71) Applicant: Holonis, Inc., San Diego, CA (US)

(72) Inventors: Richard B Hollis, San Diego, CA (US); Hayden S. Hollis, San Diego, CA (US); Zachary Schenkler, San Diego, CA (US); Arvind Morwal, San Diego, CA (US); Chetan Patel, Ahmedabad (IN)

(21) Appl. No.: 14/407,438

(22) PCT Filed: Jun. 14, 2013
(86) PCT No.: PCT/US13/45970

§ 371 Date: Dec. 11, 2014

Related U.S. Application Data
(60) Provisional application No. 61/660,624, filed on Jun. 15, 2012.
(60) Provisional application No. 61/781,987, filed on Mar. 14, 2013.

(51) Int. Cl. H04L 29/06; G06F 17/30; G06F 3/0482

(52) U.S. Cl. CPC H04L 65/403; G06F 3/0482; G06F 17/30864

(57) ABSTRACT

Disclosed herein are systems and methods for internet publishing. In some aspects, the systems and methods may be implemented by software designed for users such as, for example, small businesses, to manage and implement an online digital strategy. A digital web-based platform, for example, may be used to establish and expand the online presence of a brand. In some aspects, the systems and methods may be implemented to publish, syndicate, and monetize content in an automated and seamless manner from a single interface as well as to monitor and respond to information relevant to such content.

### CROSS-REFERENCE TO RELATED APPLICATIONS

This application claims priority to U.S. Provisional Application No. 61/660,624, filed on Jun. 15, 2012, and U.S. Provisional Application No. 61/781,987, filed on Mar. 14, 2013, and incorporates both of these provisional applications and all appendices thereto by reference in their entirety.

### BACKGROUND

1. Field

This disclosure generally relates to systems and methods for publishing and distributing information on a computer network such as the internet. More specifically, this disclosure relates to a platform that provides a user, such as a small business, a digital space that can collect, analyze, and publish content.

2. Description of the Related Art

With the exponential growth of the internet, businesses have many online tools available to them. But businesses may lack a standardized or centralized way to manage such tools. Each tool, for example, may require a business to learn how to use a new interface, set up and populate an account, and use the tool in an effective manner. Such a fragmented approach may not be time and/or cost effective for the business.

Consumers are presented with many choices when looking for goods and services online. Search engines attempt to find the most relevant results in a variety of manners. Often, business pay search engines for key words and/or links to improve their search ranking results. Consumers may rely on reviews from other consumers to help select good or services that are offered.

The increase in available tools for both businesses and consumers to electronically engage and obtain information about one another has been beneficial to both, but complexities prevent effective utilization of these tools. Methods and systems to automate and simplify processes and otherwise increase the abilities of businesses to engage electronically with both other businesses and with consumers are needed.

### SUMMARY

The systems, devices, and methods disclosed herein each have several aspects, no single one of which is solely responsible for their desirable attributes. Without limiting the scope of the disclosure, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description,” one will understand how the features of the devices and methods disclosed herein provide advantages over other known devices and methods.

In some embodiments, the systems and methods disclosed herein can be implemented by software designed for users, businesses for example, to manage and implement their online digital strategy. A digital web-based platform, for example, can be used by businesses to establish and expand their brand's online presence. The systems and methods can be implemented by users to publish, syndicate, and monetize user work as well as to monitor and respond to information relevant to the user's work. The platform as implemented with the hardware and software as described herein provides significant advantages to businesses over other platforms such as Facebook and LinkedIn for enhancing and managing their electronic interactions with other businesses and consumers.

Some embodiments comprise a software framework having a modular architecture. Modules can comprise independent software applications and/or processes that can deliver relevant and customizable feature sets to different users. For example, modules can be business specific with the goal of attracting and/or retaining customers.

Some embodiments comprise a desktop managed environment. The systems can be capable of integrating exterior web services from any site, software, or platform operating on the internet. In some embodiments, the desktop managed environment includes a dashboard that can interact with various applications and modules. Some embodiments include data mining modules, fractal, predictive mathematics and/or fourth dimensional database systems that can be structured to contain metrics, analytics, and interfaces capable of extracting intelligence and insight for a variety of applications. Some implementations allow for interaction with other websites, for example interaction with social media websites.

The systems can comprise a plurality of unique integration points. The integration points can be used to assemble and display, for example, a web page. The system can allow users to self-publish information on a web page and/or web site. In some embodiments, the users provide information to the system and the system in turn creates web page and/or web site content with automation and intuitive processes.

In some embodiments, modular components of the system are coupled to function as a whole. The system can be completely scalable within a software and/or web-based architecture that combine modular applications. The modular applications can define an entire environment on which the applications run. System level components as well as application level components can be extracted to result in a variety of configurations and components.

In some embodiments the systems includes and/or interacts with at least one social media component. Social media components can include, for example, Twitter or Facebook. Modular components and/or applications can combine multiple types of content (including social media content), create content (including social media content), and publish the content within a specific section of a larger software or web based platform.

Some embodiments include webpage structures with embedded configurations for optimization of search engine discovery and social media sharing. Content pathways and hierarchies can be configured as directories for each media element and can support standardized large scale search page density principals.

Some embodiments include dual on-page navigation functionality. For example, a specific account section can be included as part of a larger system. The section can include a method of supplying a user with dedicated and personally configurable navigation elements which can satisfy one or both standard search engine best practices for discoverability and/or best practices for social media sharing. Some embodiments include static elements that are supported by dynamic icons on second and third tiers, with links that access specific functions, display aspects, and integrate with third-party systems.

In some embodiments, the system includes content from media outlets, user conversations, and/or customer reviews and the like that are centralized around specific pages where that content is embedded or placed. Content management systems can allow for unlimited page creation. Each page generated can be engineered to embed highly optimized coding and structured for maximum potential search discoverability and social media sharing.

In some embodiments, the system includes an engine which seamlessly and effortlessly connects a user's social media account to a social media business platform. The engine can utilize an authorization parent which controls, organizes, and manages OAuth HTTP API requests anywhere on the web and for any specific account created on the platform. The process can include centralized broadcasting/syndication “push” which delivers optimized presentation of newly created or archived media content specific to the user directly into a web page, wall, stream, tweet, or announcement for any social media network.

In some embodiments, the systems and methods can integrate API requests and/or other inbound data communication protocols to capture and display reviews and comments about the user and/or the user's business and publishes the reviews and comments anywhere on the web. For example, the system can include a search engine spider to crawl well known or emerging review sites, import user based communications specific about the user and/or the user's business entity to the platform, and display the communication in a “digital space,” for example, a dashboard reporting center. In some embodiments users can then export the content that is imported to, for example a webpage, and/or create content in response to the imported communications.

The system can include a platform comprising “digital spaces.” A “digital space” is a combination of computer memory and computer processor instructions that are configured to store content created by a given platform subscriber, display some or all of the stored content to visitors of the platform in response to visitor search queries, push some or all of the stored content and/or links to some or all of the stored content to servers and storage locations on the internet different from the memory associated with the digital space, and present to the platform subscriber a user interface (sometimes referred to as a dashboard herein) allowing the subscriber to control some or all of the above described functionality. As such, each digital space can be accessed by at least one subscriber. In some embodiments, subscribers can create content and publish the content in selected media categories. In response to this publication, the system can automatically generate a unique RSS feed for each media category that the users publishes into. Distribution services can extend each feed type as an outbound marketing tool into local RSS search engines, popular readers and/or other websites.

Some embodiments include systems and methods for end-users or consumers to join and interact with any platform or technology developed by the user. For example, the systems can archive and track the media content and historical references for the life of the user. Users that are given access to the platform can engage in one-to-one direct communication with other user accounts on the platform. The system can collect specific data on consumer and/or user behavior, product choices, communication sequences, conversation modeling, and many other mathematical factors. This user and/or consumer data can be embedded into enterprise analytics products.

A user's digital space may also include an integrated marketing center application. The application can be displayed in a user's dashboard. The marketing center can utilize content and media creation assets and suggest a marketing approach specific to the user. Processes can monitor specific interactions with consumers, geographic and industry category trends, historical decisions and trends, and third-party input. The system can then suggest insights and standardization for distribution across social channels, paid search channels, banner, and localized GEO Mobile interactions.

In some embodiments, a user's digital space can include systems and processes constructed from an Abstract Factory Pattern to recreate the directory, experience, and media assets of the user's business on the platform into a social network fan or account page. The systems and methods can include managing complex API integrations with existing and emerging social networks and carrying third-party integrations from one platform to another to provide the user's business with value in consuming products that previously did not operate well cross-platform.

In some embodiments, a user's digital space can include systems and processes that can track and discover factors which affect SEO rank positions for keyword searches by end-users. The methods can abstract from current web crawler approaches by compiling data from standard sources, social sources, media sources, communication sources, syndication and user oriented re-syndication action sources, and use proprietary mathematical models for distilling this data into easily recognizable actions triggered by content and media creation. The system can provide suggestions to the user and or display the results in the user's digital space.

In some embodiments, the platform creates a run-time environment, creating a virtual operating system and/or digital space existing on the cloud. Essentially this may function as like a cloud based IOS operating system that manages applications which can be configured and consumed for an endless variety of purposes. In some embodiments, application programming interfaces (API's) are used to integrate a user's digital space with other platforms, for example social media platforms. In some embodiments, API's are used to integrate a user's digital space with the user's own personal and/or business webpage/web site.

Communication across platforms is often fragmented and businesses may lose customer engagement and opportunities through lack of prompt and personalized follow through. As such, in some embodiments, the platform implements a method whereby the user may choose to integrate mail, communication, and messaging from any other platform, ISP or ESP. This can be achieved through API-to-LDAP configurations and an open protocol for handling routing, A records and DNS records at the registrar level.

The systems and methods disclosed herein can include a method for tracking the unique patterns of consumer behavior from origin of discovery from the user to where those interactions and points of historical conversation take place. Customer relationship management products can be designed to interpret this interaction through complex database queries. The system can insert tags into the timeline view of each user as an aggregated method of seeing the entire life cycle for each end-user connected to the user's business.

In some embodiments, a digital space can be launched for any social media business or large scale entity wanting to empower sales or marketing teams with dedicated publishing spaces for direct one-to-one interaction with consumers. This single “push” management offers highly scalable opportunities to manage huge networks like hosted datacenters. Digital spaces can be linked and information can be shared and tracked in order to monitor to development, growth, new product releases, and/or enhancements offered by related users.

In some embodiments, the platform can include systems and methods that can extract keyword relevancy at the semantic and natural language level. The methods of collection can focus on internal interaction of the platform or any deployed platform anywhere on the web, accesses content spiders which crawl the web, and/or accesses Google's index and/or Facebook's Social Graph. The process can compile massive contextual information into an intuitive interface that offers full sentence related suggestions that are highly relevant, while the business is in the process of creation.

In some embodiments, the platform can include systems and methods that can collect object-to-action-to-communication-to-conversion metrics for all behavior of consumers and businesses across the web and across any social business platform. The information can be compiled into complex 4th dimensional database systems. A method can then supply analytic measurements and insightful degrees of separation for social interaction, and/or global economic views.

In some embodiments, a computer implemented internet publishing platform can comprise one or more servers that can comprise data storage space defining a plurality of digital spaces available to a corresponding plurality of platform subscribers. One or more software modules may be configured to present user interfaces to subscriber computers coupled to the internet that allow access to the digital spaces for uploading information and content to the digital spaces and for receiving information and content from the digital spaces. One or more software modules may be configured to receive and store content in a plurality of media formats received from the plurality of platform subscribers. One or more software modules may be configured to integrate items of content received from the plurality of platform subscribers into separate web pages available to at least some search engines coupled to the internet. One or more software modules may be configured to search at least portions of the internet for information related to at least one of the plurality of subscribers, to store the information in one or more of the digital spaces, and to present the information to at least one subscriber. In addition, one or more software modules may be configured to send items of content received from the plurality of subscribers to social media sites coupled to the internet.

In some embodiments, a method of publishing user created content to a wide-area-network comprises receiving a plurality of content items from a user in a corresponding plurality of content formats and integrating each item of the content into a separate web page available to search engines connected to the wide area network. In some aspects the content may be sent to a user selected destination on the wide-area network.

Is some embodiments, a computer implemented internet publishing platform comprises one or more servers including data storage space. The storage space may include a plurality of digital spaces available to a plurality of platform subscribers. The storage space may also include one or more software modules. The software modules may be configured to present user interfaces to subscriber computers coupled to the internet that allow access to the digital spaces for uploading information and content to the digital spaces and for receiving information and content from the digital spaces. The modules may be configured to receive and store content in a plurality of media formats received from the plurality of platform subscribers. The software modules may be configured to integrate items of content received from the plurality of platform subscribers into separate web pages available to at least some search engines coupled to the internet. The software modules may be configured to search at least portions of the internet for information related to at least one of the plurality of subscribers, to store the information in one or more of the digital spaces, and to present the information to at least one subscriber. The software modules may configure to send items of content received from the plurality of subscribers to social media sites coupled to the internet.

In some embodiments, a computer implemented method of managing an internet presence may comprise accessing a data storage space over the internet, uploading content to the data storage space, selecting a plurality of additional destination sites on the internet for the uploaded content, and retrieving information from the data storage space collected from the internet that relates to third party access to, use of, or commentary on the uploaded content. The one or more servers may be configured to provide an integrated programming environment to execute one or more unique application programs. A user interface of an application program may be displayed within one or more of the user interfaces presented by the one or more software modules.

In some aspects, an integrated programming environment may comprise an application programming interface. The application programming interface may enable a plurality of software components to communicate with each other. The application programming interface may enable a plurality of software components to communicate with the one or more software modules. The application programming interface enables at least one of the one or more unique application programs to communicate with a network.

In some aspects, a computer implemented internet publishing platform may include a software module configured to transmit a network message to a mobile device. The network message may be configured to be received and processed by an internet publishing platform application program executed on the mobile device. The internet publishing platform may include one or more software modules. The software modules may be configured to create and publish a plurality of media or content types to unique web pages hosted by the internet publishing platform. The software modules may be configured to add one or more data tags to the unique web pages to increase the ranking of the unique web pages by an internet search engine. The software modules may be configured to publish a really simple syndication (“RSS”) feed in response to the addition of media or content into the digital space. The software modules may be configured to submit the really simple syndication feed to one or more RSS search engines in response to the addition. The software modules configured to retrieve content from a RSS feed and store the retrieved content in the digital space.

In some aspects, the software modules may be configured to make available for download a browser plugin configured to integrate with the publishing platform. The browser plugin may be further configured to collect metrics on traffic patterns or websites visited. The browser plugin is may be further configured to display information indicating a digital conversation corresponding to the digital space on a user interface.

In some aspects, the software modules may be configured to establish a relationship between selected subscribers, wherein sharing of information, media, content, files, contacts, conversations or connections between the selected subscribers is based, at least in part, on the relationship. The software modules may be configured to periodically assigning value points to a plurality of media types within the digital space based on a locality or vertical category of the digital space. The software modules may be configured to transmit a network message configured to cause a receiver to display at least two different media types in a single list view. The software modules may be configured to receive business information from a user, and to configure one or more directories, services, local map searches, mobile applications or search engines in response to receiving the business information. The business information may be contact information of a subscriber.′

In some aspects, the software modules may be configured to receive information relating to a subscriber's business type, industry, category and/or geography. The modules may determine a list of keywords based on the received information and insert the keywords or meta tags based on the keywords into content pages corresponding to the subscriber. The modules may automatically insert the keywords and/or meta tags from relevant industry related keywords into content when the content is uploaded. The modules may automatically distribute content through a plurality of pre-selected and/or pre-authorized distribution channels. The modules may be configured to provide a messaging system to users of the publishing platform. The messaging system may be configured to integrate messages received from a plurality of social network messaging systems. The messaging system may be configured to provide a send message feature that sends a message to a plurality of destinations. The destinations may be hosted by a plurality of social network messaging systems.

In addition to the systems and methods described above, a computer-implemented system for performing a method according to various embodiments of the invention is also provided. The system, also referred to as an apparatus, includes a web server connected to a network, for example, the Internet. The web server further comprises a database and an application for providing an interface and performing the methods according to an embodiment of the invention. Methods according to the present invention are performed by software residing on the web server, or on other servers on the network that are accessible to the web server. The web server may contain web pages and other information transmitted to the network in response to a request received from the network. The system may also include one or more secondary web servers connected to the network.

In addition, a computer readable media including instructions operative to configure a processor to perform the above method is also disclosed. This computer readable media may be included as part of a web server, or may be accessible by the web server. The computer readable media may be accessed by one or more web application programs running on one or more web servers that load and execute the instructions stored on the computer readable media. These instructions then cause the web server to perform aspects of the method discussed above.

A more complete understanding of the methods, systems, and computer readable media will be afforded to those skilled in the art, as well as a realization of additional advantages and objects thereof, by a consideration of the following detailed description and attached appendices.

### BRIEF DESCRIPTION OF THE DRAWINGS

The foregoing and other features of the present disclosure will become more fully apparent from the following description and appended claims, taken in conjunction with the accompanying drawings and appendices. The drawings and appendices disclose illustrative embodiments. They do not set forth all embodiments. Other embodiments may be used in addition or instead. Understanding that these drawings and appendices depict only several embodiments in accordance with the disclosure and are not to be considered limiting of its scope; the disclosure will be described with additional specificity.

FIG. 1 is an example block diagram illustrating a system for delivering a web application over a network according to some embodiments.

FIG. 2 is an example block diagram illustrating a typical architecture of a web server that may implement one of the disclosed operative embodiments.

FIG. 3 is an example block diagram illustrating an embodiment according to the present invention.

FIG. 4 is an example block diagram of a system and method of distributing content according to some embodiments.

FIG. 5 is an example block diagram according to one embodiment of a process flow for distributing content to from a subscriber's digital space.

FIGS. 6 and 7 are example block diagrams illustrating the syndication of content from a subscriber's digital space according to some embodiments.

FIG. 8 is an example block diagram illustrating one embodiment of a search engine optimization analysis tool according to some embodiments.

FIG. 9 is an example simplified block diagram illustrating a system and method for managing and monitoring media channels according to some embodiments.

FIG. 10 is an example block diagram illustrating a system and method for indexing and searching content according to some embodiments.

FIG. 11 is an example block diagram illustrating an embodiment of interaction engines on the platform.

FIG. 12 is an example block diagram illustrating architecture for digital spaces on the platform and indexing thereof according to some embodiments.

FIG. 13 is an example block diagram for a system and method for distributing video and/or audio according to one embodiment.

FIG. 14 is an example block diagram block diagram for a system and method for distributing photos according to some embodiments.

FIG. 15 is an example block diagram for a system and method for distributing textual content according to some embodiments.

FIG. 16 is an example block diagram for a system and method for creating and distributing deals according to some embodiments.

FIG. 17 is an example block diagram for a system and method for retrieving, publishing, and distributing, content from RSS feeds according to some embodiments.

FIG. 18 is an example block diagram for system and method for e-commerce on according to some embodiments.

FIG. 19 is an example block diagram of a social media engine according to one embodiment.

FIG. 20 is an example block diagram for a system and method for publishing content that is uploaded to the platform according to some embodiments.

FIG. 21 is an example block diagram for a system and method for authorizing distribution channels according to some embodiments.

FIG. 22 is an example flow chart illustrating a tiered sorting and/or ranking of search query results according to some embodiments.

FIG. 23 is an example block diagram illustrating an embodiment of a business ranking system according to some embodiments.

FIG. 24 is an example block diagram illustrating an embodiment of a media ranking system according to some embodiments.

FIG. 25 is an example block diagram of a point system for specific media according to some embodiments.

FIG. 26 is an example block diagram of a compliance engine according to one embodiment.

FIG. 27 is an example block diagram of illustrating an embodiment of an institutional hierarchy.

### DETAILED DESCRIPTION

In the following detailed description, reference is made to the accompanying drawings and appendices, which form a part hereof. In the drawings, similar symbols typically identify similar components, unless context dictates otherwise. The illustrative embodiments described in the detailed description, drawings, appendices, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures and appendices, can be arranged, substituted, combined, and designed in a wide variety of different configurations, all of which are explicitly contemplated and make part of this disclosure.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

### DEFINITIONS

Various terms and acronyms may be used throughout the detailed description, including the following:

Application: Within the context of computer hardware and software, an application is a set of one or more computer programs that performs a function when executed within a computer hardware device. If the set is comprised of plural programs, the programs are coordinated to perform a function together; such programs may also perform other functions individually. Similarly, a program may be comprised of plural modules that perform certain functions individually and other functions when combined in various ways.

Client-Server: A model of interaction in a distributed system in which a program at one site sends a request to a program at another site and waits for a response. The requesting program is called the “client,” and the program which responds to the request is called the “server.” In the context of the World Wide Web (discussed below), the client can be a “Web browser” (or simply “browser”) which runs on a computer of a user. The program which responds to browser requests by serving Web pages is commonly referred to as a “Web server.”

Cookies: A technology that enables a Web server to retrieve information from a user's computer that reveals prior browsing activities of the user. The information item is stored on the user's computer (typically on the hard drive) is commonly referred to as a “cookie.” Many standard Web browsers support the use of cookies.

Distributable application: An application coded in a language, such as the JAVA language developed by Sun Microsystems, Inc. and currently owned by Oracle, Inc., such that the application may be distributed over a network, such as the Internet, and be successfully executed on a variety of computer hardware models running various operating systems.

Hyperlink: A navigational link from one document to another, or from one portion (or component) of a document to another. Typically, a hyperlink is displayed as a highlighted word or phrase that can be selected by clicking on it using a mouse or other pointing device to jump to the associated document or documented portion.

Hypertext System: A computer-based informational system in which documents other types of computer files are linked together via hyperlinks forming a user navigable “web.”

Information Exchange Group: A general term encompassing a particular set of protocols or rules for information sharing, together with a particular set of shared information or data collected or generated under the associated rules and protocols, and the users (or other sources) contributing information to, or accessing information in, the shared set of information. As implemented on the Web, information exchange groups include newsgroups, bulletin boards, message boards, chat rooms, and “Webrooms.”

Internet: A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”): Used herein to refer generally to both (i) a distributed collection of interlinked, user-viewable Web pages and other linked data and distributable applications that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Page: A hypertext file or document that is encoded using a language such as HTML for viewing on a client computer using a browser application. A Web page may include visible components, such as text, images, hyperlinks, and a background, and/or invisible components, such as meta tags and formatting instructions. In comparison to the term “Web page,” the more general term “page” encompasses many other types of computer files that are not necessarily encoded for viewing using a browser, e.g., text files, bit-maps, audio files, and so forth.

Web Site: A computer system that serves informational content over a network using the standard protocols of the World Wide Web. Typically, a Web site corresponds to a particular Internet domain name, such as “electronsearch.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (HyperText Markup Language): A standard coding convention and set of codes for attaching presentation and linking attributes to informational content within document (HTML 2.0 is currently the primary standard used for generating Web documents, although it should be appreciated that other coding conventions could be used within the scope of the present invention.). During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally, in specifying how the Web browser is to display the document, HTML tags can be used to create links to other Web documents (commonly referred to as “hyperlinks”).

HTTP (HyperText Transport Protocol): The standard World Wide Web client-server protocol used for the exchange of information (such as HTML documents, and client requests for such documents) between a browser and a Web server. HTTP includes a number of different types of messages that can be sent from the client to the server to request different types of server actions. For example, a ‘GET’ message, which has the format GET <URL>, causes the server to return the document or file located at the specified URL.

URL (Uniform Resource Locator): A unique address which fully specifies the location of a file or other resource on the Internet. The general format of a URL is protocol//machine address:port/path/filename. The port specification is optional, and if no port-is specified, the browser defaults to the standard port for whatever service is specified as the protocol.

Subscriber: A business, sole proprietor, corporation, institution, or organization that will be purchasing and interacting with the tools and services developed for the platform.

Registered user: A general end-user who has registered, signed-up or connected with any platform deployed in any industry, or downloaded software to be installed on either the desktop, the social media profile or the browser.

End-user: A general user that will find, discover, navigate, contact, or consume information related to any business on any platform

The foregoing definitions are not intended to limit the scope of the present invention, but rather are intended to clarify terms that are well understood by persons having ordinary skill in the art. It should be appreciated that the defined terms may also have other meanings to such persons having ordinary skill in the art. These and other terms are used in the detailed description below.

In the following description and appendices, specific details are given to provide a thorough understanding of the examples disclosed therein. However, it will be understood by one of ordinary skill in the art that the examples may be practiced without these specific details or with additional details known by those of skill in the art. For example, electrical components/devices may be shown in block diagrams in order not to obscure the examples in unnecessary detail. In other instances, such components, other structures and techniques may be shown in detail to further explain the examples.

### Overview

Some embodiments of the present disclosure comprise a cloud based software system or platform. The software system is a designed to empower local or national businesses with tools to effectively manage their online digital strategy. In some aspects, the software system can act as a social media business platform. The software system may include a plurality of modules that can measure, syndicate, market, and/or manage the creation and/or distribution of media and content to search engines, and throughout the web. The modules may convert published content into discoverable content and used to engage, converse with and/or retain consumers and/or used to promote products and/or services being offered by subscribers. The software modules may be accessed by subscribers and configured to optimize the published content to increase the discoverability of the content by search engines. For example, the platform can include one or more software modules configured to interact with social media platforms. Thus a single access point for subscribers to engage and converse with consumers may be provided. Published content can be indexed on the subscriber's self-branded media network, syndicated to other platforms, shared with social networks, and/or integrated as an RSS using a single platform.

Some embodiments include an application programming interface (“API”) that subscribers may access. The API may include a unique, centralized desktop managed environment for each subscriber. The desktop managed environment may include a dashboard that can display the interfaces with the software modules that provide the numerous functionalities within a central area.

In some embodiments, a cloud based software system can integrate exterior web services from any site, software, or platform operating on the web. The software modules may be configured to data mine any site, software, or platform operating on the web. Such data may be used by the system to provide fractal and predictive mathematics and fourth dimensional databases to containing metrics, analytics, and interfaces capable of extracting intelligence and insight for a variety of applications. The data may be displayed to a subscriber in a standardized in manner for ease of consumption. The systems disclosed herein may provide mathematical ordering or localized interactive relevancy based on consumer consumption, history, networking, and exchange of information.

Some embodiments include a social media business platform. Social media may be the most powerful vehicle for transparency marketing on the web and advancements provided herein employ usability engineering to convey an enhanced experience for consumers. In some embodiments, the platform allows for publishing, syndication, measurement, and management of discoverable, user generated content. As such, an easy to use and comprehensive tool allows for a subscriber to implement their digital strategy. The platform may provide “white label” solutions designed to create distribution and consumption of the platform by groups, organizations, institutions and other entities.

In some embodiments, the platform is designed to capture, optimize, present in a structured format, and syndicate content across the web. The content may include embedded consumer engagement, conversion, and retention capabilities. The platform may also include integrated and interconnected features designed to measure, suggest, manage, streamline, and empower the subscriber with search marketing, social media, productivity, customer management, advertising, branding, analytics, messaging, and discoverability tools. The platform may also include browser plug-ins, dedicated pages capturing historical preferences and interactions, content tracking, embedded tagging, and one-to-one communication features providing a private wallet type of effect that may follow the user into any platform social media channel or website.

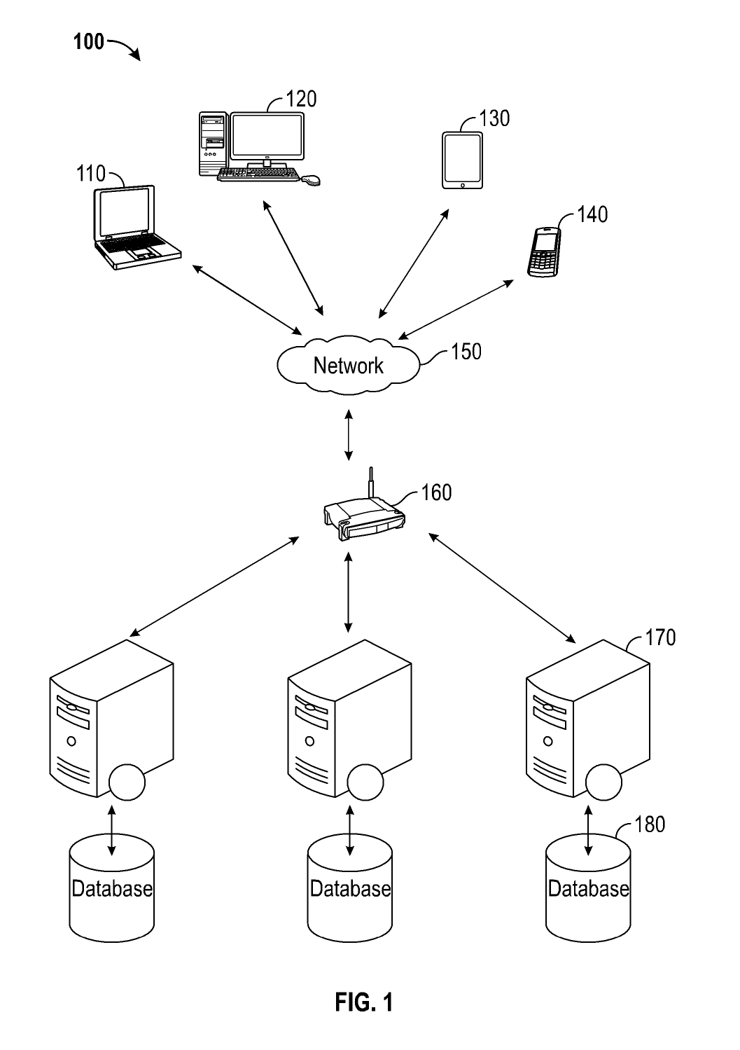

Referring to FIG. 1, a block diagram is illustrated of a network employing a method and system according to the invention. It is anticipated that the present web application system 100 operates with a plurality of computers which are coupled together on a network, such as the Internet 150, or other communications network. FIG. 1 depicts a network that includes user computers 110, 120, 130, and 140 that communicate with one or more web servers 170 though communication links that include the Internet 150. The user computers 110, 120, 130, and 140 may be any type of computing device that allows a user to interactively browse web sites, such as a personal computer (PC) that includes a web browser (e.g., Microsoft Internet Explorer™ or Google Chrome™). Suitable user computers equipped with browsers are available in many configurations, including handheld devices 140 (e.g., Apple iPhone™, Google Android, or RIM Blackberry), personal computers (PC), laptop computers 110, workstations 120, television set-top devices, tablets (130) and so forth.

The one or more web servers 170 may be optionally managed by a load balancer 160. Load balancer 160 may receive requests from computer network 150 and route these requests to one or more web servers 170 based on a variety of criteria. These criteria may optionally include the current load of each web server 170, session information included in the network request, a round robin counter maintained by load balancer 160, or other criteria.

One or more web servers may also communicate with one or more databases 180. These databases may be in a mirrored or striped configuration to support the data storage requirements of web applications running on web server(s) 170.

The web server(s) 170 includes a server computer running a web interface application and capable of selectively delivering data files, such as HTML files, to the user computers using a protocol such as HTTP. Web server 170 may also dynamically generate content for delivery to user computers in response to a request from a user computer. The content may be generated by web server 170 directly, or may be generated by other computers linked to web server 170 in response to a request from web server 170. Web server 170 may then forward the requested content to a user computer over network 150.

In addition to exposing a user interface capable of being viewed on a browser as described above, web server 170 may also expose a web services interface on network 150. The web services interface may use the SOAP protocol to provide the web services or any other protocol known in the art. Such interfaces may provide an ability for other network based programs to interface with the meal organization and scheduling methods provided by web server 170 in one aspect of the present invention.

Web server applications may be coded in various programming languages, such as Java, Perl, C#, C, or C++, and are customized to run on their respective servers 170. Web servers 170 may also include applications utilizing a variety of specialized application languages such as Microsoft Silverlight™, or Adobe Flash™ to implement user interfaces displayed on the user computers. These specialized applications may be integrated with files or dynamic content provided by Web server 170 to the user computers in response to a request from those user computers.

Web server applications, such as those running on web server 170, also typically interface with a database application, such as a SQL Server™ engine from Microsoft Corporation, Oracle™ database engine, or MySQL as part of their architecture. These database applications may control or manage database servers 180 illustrated in FIG. 1.

Web applications running on web server 170 may access a database of web pages, distributable applications, and other electronic files containing information of various types. Web pages or other electronic files may be viewed on the displays of the user computers by a suitable application program residing on a user computer, such as a browser, or by a distributable application provided to a user computer by the web server 170. It should be appreciated that many different user computers, many different web servers, and many different application servers of various types may be communicating with each other at the same time.

The present invention allows a user to organize, display, and integrate information. Users can perform the methods of the present invention by interacting with browsers on their user computers via web pages. Web pages are generally requested by communicating an HTTP request from a browser application. The HTTP request includes the Uniform Resource Locator (URL) of the desired web page, which may correspond to a web page stored at a destination web site, such as web server 170. The HTTP request is routed to the web server 170 via the Internet 150. The web server 170 then retrieves the requested web page, identified by a URL, from database 180 and communicates the web page across the Internet 150 to the browser application running on user computers 110, 120, 130, or 140. The web page may be communicated in the form of plural message packets as defined by standard protocols, such as the Transport Control Protocol/Internet Protocol (TCP/IP), although it should be appreciated that communication using other protocols would be within the scope of the invention.

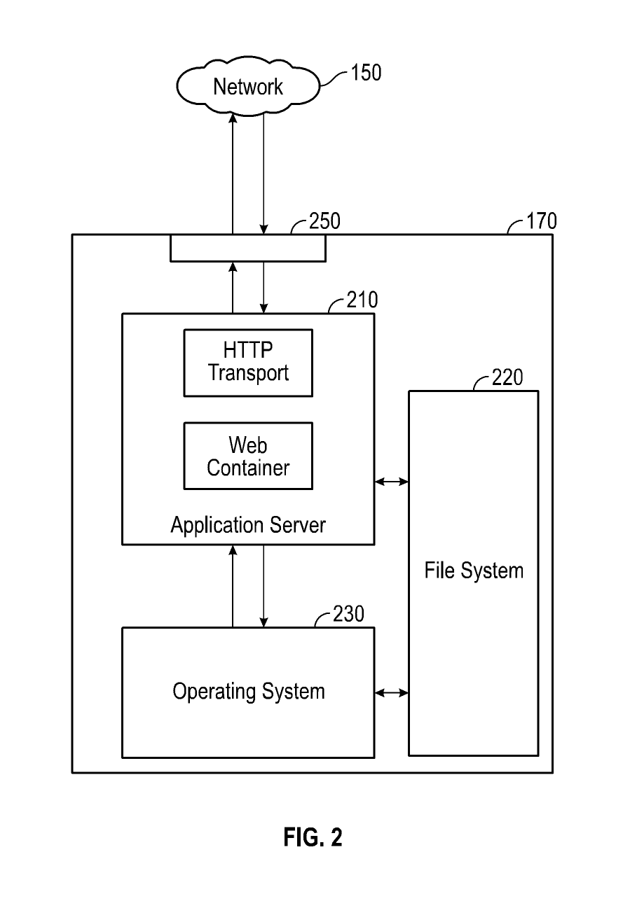

FIG. 2 is a simplified block diagram illustrating the internal software architecture of one embodiment of web server 170. Web server 170 may be implemented using one of several standard hardware web server platforms including general purpose computers or specialized web server computers from anyone of a number of manufacturers to include Hewlett Packard, Apple, Dell, IBM, or the like. These web server hardware platforms may run anyone of a number of operating systems 230 to include Microsoft Windows Server, Linux, or several other versions of UNIX. Web Server 170 may also be virtualized within a server virtualization system such as VMW are to enable multiple web servers or other applications to operate on one individual computer.

Running on these hardware and operating system web server platforms may be software applications including what is known in the art as an application server 210. Applications servers may include Apache Tomcat, Web sphere, or Jboss. Simplified web application architectures may also be used, to include http servers such as an Apache http server running cgi scripts, or open source applications such as Drupal or Jumla.

As illustrated in FIG. 2, Application Server 210 running on web server 170 interacts via a network port 250 with a network 150. Application server 210 may receive requests from the network 150 generated by user computers of FIG. 1 over network. port 250. Within Application server 210 may be a web container containing one or more web application programs as described above. These applications may respond to the network requests generated by user computers to deliver web content back to user computers over network 150. These application programs may include instructions that configure a processor running in web server 170 to perform the methods of one or more operative embodiments described herein.

Web server 170 also includes a file system 220. Application server 220 may read and write data to file system 220 in order to respond to requests from user computers over network 150. File system 220 may store static files including html files that define one or more aspects of a user interface provided by Application Server 210 to user computers over network 150. File system 220 may also store instructions of the web applications described above that cause the processor running in web server 170 to perform the method of one or more of the operative embodiments described in this application.

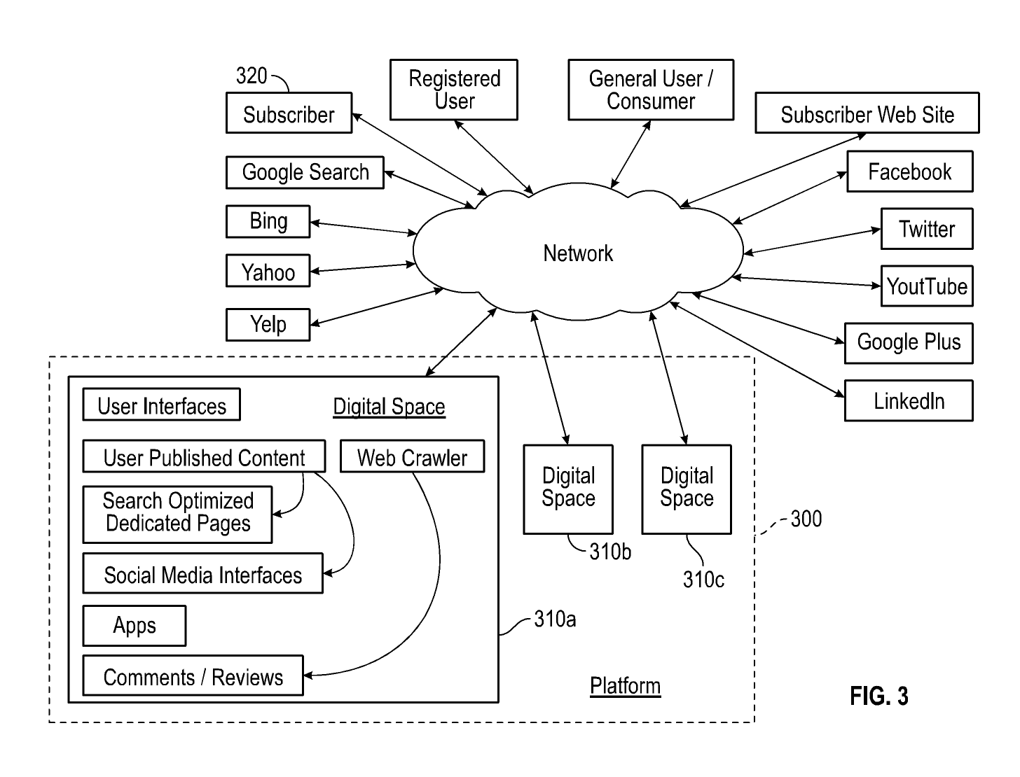

FIG. 3 is a simplified block diagram illustrating a non-limiting embodiment of a platform 300 according to the present invention. As show, the platform includes a plurality of digital spaces 310a-c. Each digital space can correspond to a particular subscriber, or group of subscribers, which may be one or more business entities. The platform 300 can be connected to the internet. Subscribers 320 of the platform 300 can access the digital space via the internet. Subscribers 320 can access information supplied to the digital space and/or add content to the digital space.

An example digital space 310a, as illustrated, includes user interfaces, subscriber published content, search optimized dedicated pages, social media interfaces, applications (“Apps”), comment/review modules, and a web crawler. The user interfaces can include desk top like functionality and may include a dashboard that displays prompts and/or receives user input. User published content can be added or removed from the digital space. In some embodiments, the user published content is accessible to general users of the internet. In some embodiments, user published content is passed to a module that can publish the content to search optimized dedicated pages such that the content can be found easily by search engines such as Google Search, Bing, or Yahoo. User published content may also be passed through a module that interacts with social media such as Facebook, Twitter, or Youtube. For example, in some embodiments, a digital space can publish content to multiple outlets with one application. The web crawler can search the web for content and or reviews from other parts of the web, Yelp for example, and display the results in the digital space.

### Digital Spaces

The platform may include dedicated digital space for each subscriber. The platform may also include dedicated digital space for each registered user. Such digital space may allow for a subscriber and/or registered user to create, publish, syndicate, manage, and/or market subscriber and/or third party content. Such content can include, for example, video, audio, photos, articles, and/or promotions/deals. One or more software modules may be accessed by subscribers and/or registered users and configured to manage and/or control the display of the content. The content of the digital space may be managed by the subscriber, a group of subscribers, a master subscriber, and/or administrators of the platform. In some embodiments, a subscriber may be able to make any page on the digital space private and/or partially private.

In general, each digital space comprises a search and content optimized subsection of the platform that is a dedicated area in which the subscriber's and/or registered user's information is physically resident after upload to the platform. For example, a subscriber may upload and publish any form of text, video, image, and/or audio media to uniquely generated landing pages that are configured to be visible to search engines. In some embodiments, the digital space comprises one or more webpages. In some embodiments, each individual item of media that is published is placed on a unique webpage. Thus, the number of pages is increased which may in turn increase discoverability of the digital space by webcrawlers and/or search engines.

In some embodiments, a subscriber's digital space is configured to include at least one navigation element. The navigation element may allow a visitor to sort by, for example, media type and then display stored media of the selected media type in a list format. The list format may include a snapshot and link to the unique webpage of the digital space that that includes the media. In some embodiments, the digital space may include one or more content channels that may be organized by, for example, subject matter and/or location. A navigation element may be provided to allow for a visitor to sort by, for example subject matter and/or location and display the results in a list format. The list format may include a snapshot and link to the unique webpage of the digital space that that includes media related to that subject matter and/or location. Such structures can capture more search results for a wider range of keywords, expand a subscriber's digital real-estate, increase landing pages, and drive more customer traffic to one or more pages of the digital space. The navigation toolbox may be customized for specific industries. The standard interface and combination of navigation structures can offer users an easily recognizable way of consuming information and/or applications generated by subscribers across the platform. That is to say, no matter what industry, locale, category, or page the consumer lands on within the platform, they will instantly be familiar with how to find and consume information, and connect with the business. This standardization may ensure that the entire experience is optimized for loyalty, adoption, and ease of use by both the business and the consumer.

A digital space may also include a virtual storefront. The storefront may enable a business to efficiently manage their advertising, branding, and online presence. The software modules may include a standard set of pre-bundled dynamic displays that users can interact with. In some embodiments, subscribers can customize the digital space and/or storefront through an interface accessible to subscribers.

The interface may include a dashboard. The dashboard may comprise one or more software modules that include interactive displays. The dashboard may allow a subscriber to edit the digital space. For example, dashboard may allow for a subscriber to reposition elements, change design choices, and manage their digital space. In some embodiments, a subscriber's dashboard includes applications and features designed to order information, generate communication and archive resources, products, and/or services from the platforms that the digital space interacts with and/or from the web in general. In some embodiments, the dashboard mimics a mobile desktop environment.

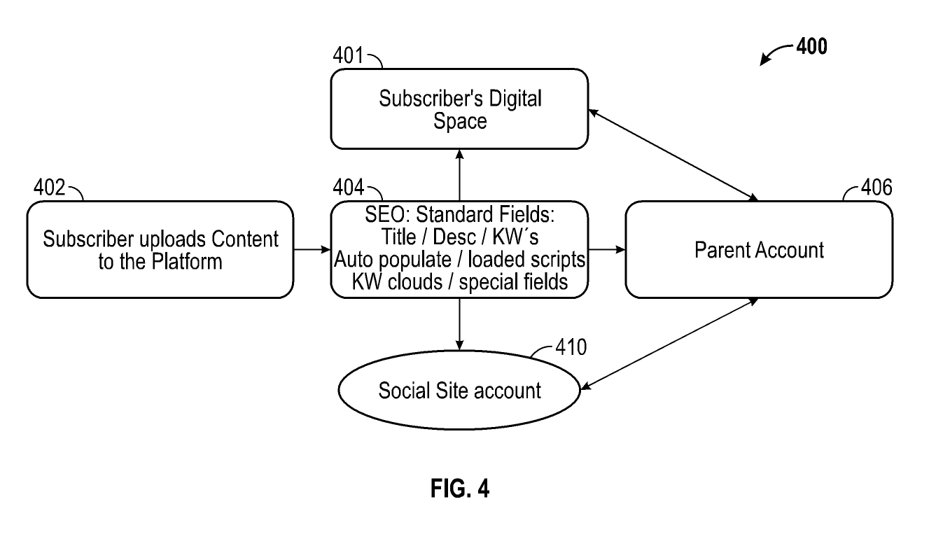

Turning to FIG. 4, a block diagram of a system and method of distributing content 400 is illustrated. A subscriber's digital space 401 may include a plurality of webpages. New webpages on the digital space 401 may be created when a subscriber uploads content to the platform 402. The uploaded content 402 may be search engine optimized in at least a partially automated manner 404. In some embodiments, the search engine optimization 404 includes prompting a subscriber for additional information about the uploaded content, labeling the content with a title, description, and keywords, and/or providing meta tags. Uploaded content that is SEO optimized may then be published on the digital space 401 and the subscriber's social media website account(s) 410 automatically. In some embodiments, a parent account 406 may be linked to the digital space 401 and the social media website account(s) 410.

### Industry Specific Logic

In some embodiments, the platform is configured to manage specific logic applied within an industry segment or vertical. Such logic may be broken down as classes allocated to application control elements, keyword elements, security requirements, standards compliance, information captured over time or though partner API's, features and usability layers per industry, and/or category contained within the industry.

The platform may include a logic handling system capable of providing superimposed control of elements that are specific to each industry, category, or sub-category. General site security protocols are often embedded. But, within the medical industry, for example, HIPAA security regulations for online transactions and information exchange are stringent. Financial security must adhere to PCI level global compliance standards and encryption is a complex science. Thus, the platform may be configured to adhere to industry standards specific for each industry. Some embodiments include an industry compliance engine. The engine can be configured to manage the security compliance required for sensitive industries.

In some embodiments, a method for managing an industry segment includes identifying a plurality of industry types and/or receiving such information from a subscriber. The method may continue by defining categories within each industry and/or receiving such information from a subscriber. In some aspects, sub-categories within each main category are further defined and/or received from a subscriber. The method may continue by defining keyword usage, meta usage database sub-sets for each industry, category, and/or sub-category. The method may continue by defining the application types served to subscribers within each industry, category, and/or sub-category. The method may continue by receiving content from a subscriber. The method may continue by embedding one or more meta tags into the uploaded content based at least in part on the industry, category, and/or subcategory information received from the subscriber. The method may continue by defining the security compliance standards for each industry. The corresponding systems architecture for storage/security protocols may then be defined as well as API level encryption standards for each industry. The method may continue by distributing tagged content to one or more distribution channels.

In some embodiments, a subscriber may be required to receive prior approval of content that is displayed in the subscriber's digital space and/or syndicated through the subscriber's channels. One or more software modules may be configured to fully or partially provide for review the content for key words or obscene content. This functionality may be referred to as a compliance engine. In some embodiments, content approval may be provided by the subscriber's parent account or company. For example, in some industries, a subscriber may be an independent contractor or agent affiliated with an organization. The organization may require that all content published to the internet be pre-approve or compliant with the organization's standards and/or advertising campaign and/or brand message. Thus, in some embodiments, content that a subscriber wishes to display on their digital site and/or syndicate must first be sent to the subscriber's organization or parent account. If the subscriber's organization or parent account approves the content, then the content may be published and/or syndicated. If the content is not approved, the content may be returned to the subscriber.

For example, in the real estate agent industry, a plurality of real estate agents may act as independent contractors under the umbrella of a national real estate company. Such companies often have contractual policies limiting what the agent may publish on their agent websites. Such companies may also desire to have each agent working under their corporate umbrella, publish content that is consistent with the company's brand. For example, the company may wish that all agents working for them have websites with the same look and feel. Thus, the platform described herein can include templates that agents can utilize so that a uniform message and/or look is displayed to users. Agents who wish to publish content to their digital space may be required to have their content first reviewed by a company representative who can approve or deny the content. If the content is approved, the content can be published on the agent's digital space and syndicated through distribution channels. Content that is not approved may be returned to the agent. The review process may be partially or wholly automated. For this application, having a platform as described above is much more effective than currently available technologies such as LinkedIn or Facebook, which do not allow master administration of this nature.

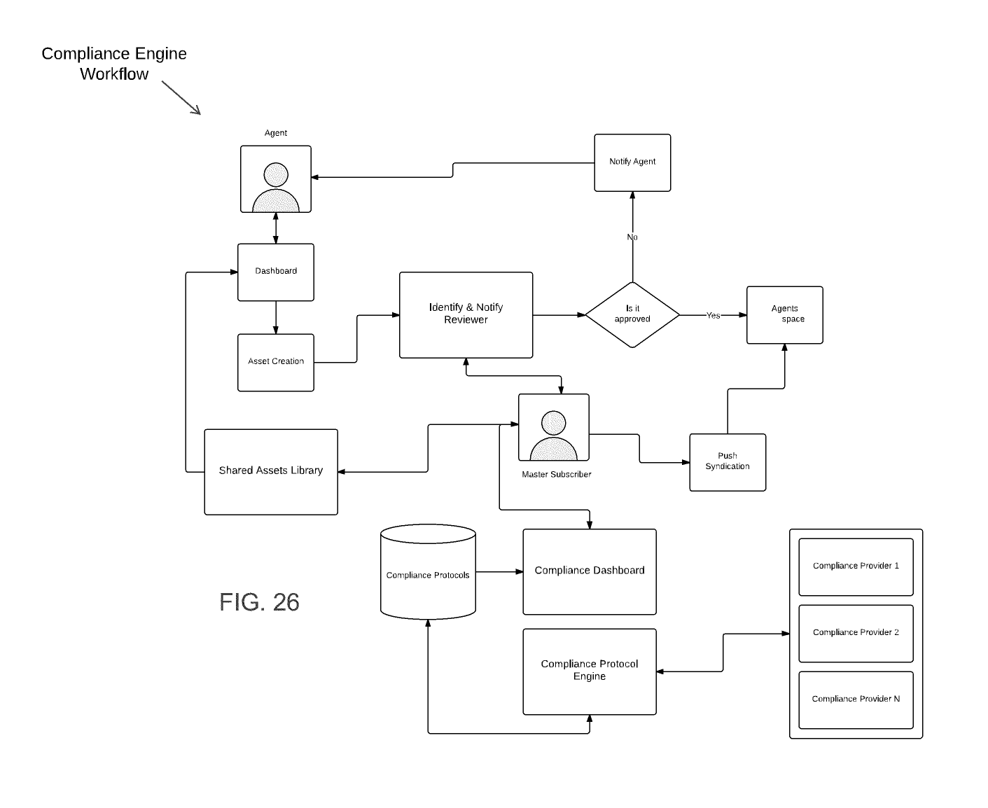

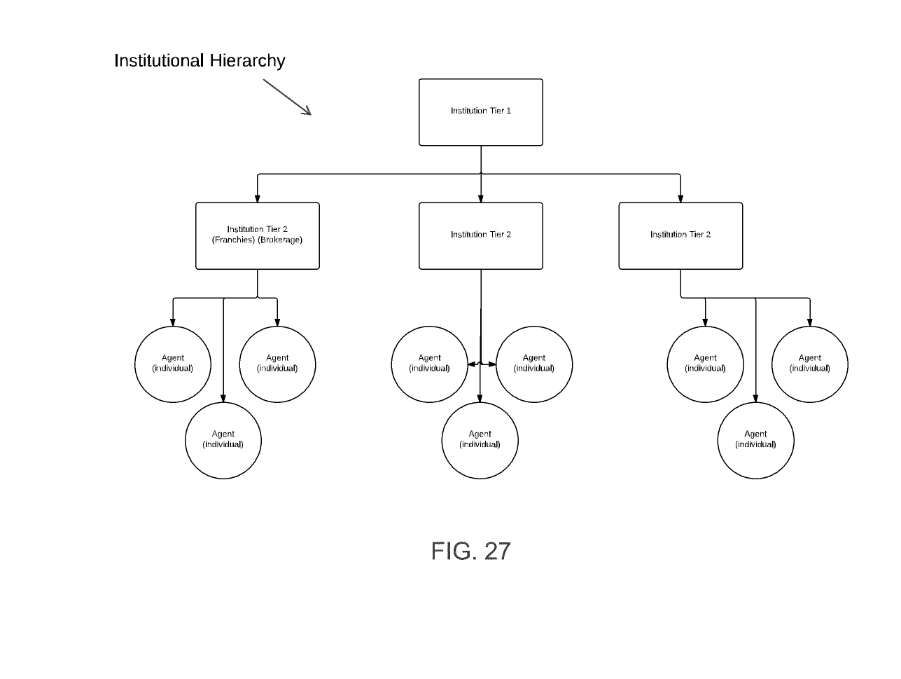

With reference to FIG. 26, an example block diagram of a compliance engine according to one embodiment is shown. As shown, an agent may interact with their dashboard by, for example, supplying content and/or selecting content from a shared assets library that is managed by a master subscriber. The agent may then create an asset that the agent wants to publish to their digital space and/or push to one or more distribution channels. Such assets may then be identified and the master subscriber, or a reviewer acting on their behalf, may review the asset. If the asset is approved, the asset may be published on the agent's digital space and/or pushed to one or more distribution channels. If the asset is not approved, the asset will not be published and the agent may be notified. The master subscriber may interact with their own compliance dashboard. A compliance protocol engine may gather compliance information from a plurality of compliance providers. The compliance information may be stored on a database and interacted with via the subscriber's dashboard. Turning briefly to FIG. 27, administration of content may include multiple tiers of administration. Thus, a large institution may be able to approve content of their franchises while franchises may be able to approve content of their agents.

### Content Publishing and Syndication

In some embodiments, systems disclosed herein are configured to capture, tag, play, and edit video content uploaded to the platform. One or more software modules may be configured to upload a single piece of video content into a unique dedicated page structure that is optimized for full search engine visibility, sharing, conversion, and broadcasting to participating channels and/or social accounts. Subscribers may create unlimited unique pages, with each page acting as a unique entry point into the subscriber's digital space. Each page can also function as a page for generating and responding to comments from customers, answering questions, and creating deeper engagement with the public through streamlined central messaging. Editing of uploaded video may be accomplished with one or more software modules configured to, for example, trim, stabilize, insert transitions, annotate, and/or add music or text to the video. Uploaded video may be edited immediately after upload or at a later time. Fields to capture meta information can be supplied to the subscriber before finalizing the public availability of the content. Subsystems such as predicative keyword and tagging insertion, help annotations, and links for industry, geographic location, and category.

In some embodiments, meta tagging is supplied by an intelligently learning keyword driven database that measures one or more factors of the upload and suggests anything from a single word to full sentences recognized as potentially optimized for that particular businesses location, industry, categories, and products. Video may be uploaded from a storage system or captured live from, for example, a webcam. In addition, mobile browsers may initiate the same action through, for example, an HTML 5 enabled interface. In some embodiments, video may uploading directly from a mobile device.

In some embodiments, systems disclosed herein are configured to edit, manipulate, tag, share, and create experiences from digital pictorial media. User generated images and/or photos may be uploaded into unique, search engine visible pages. The photos may then be published to one or more social, local search, and/or photo sharing channels. In some embodiments, uploaded images may trigger embedded editing and tagging functions. In some embodiments, a system of caching and automating logic for minimizing interior get requests through the browser by including a CDN type of approach may ensure fast and seamless delivery of each and every photo experience displayed on or off platform. Meta tags such as, micro and OG tags may be automatically generated. One or more software modules may be configured to display tag options for the subscriber to select from in order to provide flexibility when interacting, communicating, or sharing the content.

Subscribers may be able to create unlimited photo albums, title the albums, and generate meta tags against each newly created item. Each individual photo can be tagged and titled as well. Predictive keyword system within this interface may also be provided. Each uniquely generated page has the ability to capture comments specific to that uploaded content, with responses appearing in-line, or private messaging displayed between subscribers and registered users. Moreover, the end user may have the ability to share the images through social posting, email, and discovering the same content on other channels. The registered user may be able to save photos using their toolbox. The uploaded content may be published in a format which preserves the original structure or may be altered to comply with administrative restrictions or external websites and/or API's that the content is syndicated to.

In some embodiments, uploaded images may be displayed as, for example, slide shows, panorama stitching, frame effects, exposure emulator, and/or collages. Functionality may be provided to allow for a subscriber to control the arrangement, order, and/or applied effects of the images. Any file type, such as PNG, Jpeg and Gif, may be accepted. Images may be resized and/or treated for resolution, ratio, and/or saturation. Simultaneous photo uploading may be enabled to allow for the creation of large albums within very few clicks. In some embodiments, the editing software modules may be configured as a background service and may be automatically executed when images are uploaded. Images may be captured from file location on a PC, camera or device and/or through mobile browsers. In some embodiments, images taken through an application on a wireless or radio connected smartphone, tablet, or similar device interface can upload images to the subscriber's digital space directly from the hardware menus of each device.

Subscribers may create, edit, and/or delete an album of images. In some embodiments, subscribers are prompted to provide information such as, for example, titles, meta tags, geographic location, type of album, and a short description. Albums may be searched and or shared. In some embodiments, an image may be used as an advertisement or deal. One or more software modules may also be configured to provide analytic data relating to, for example, where the image is posted, image views, image clicks, comments, and conversations. One or more software modules may also be configured to provide suggestions for improvements that can increase the discoverability of the image.

In some embodiments, systems disclosed herein are configured to create and publish textual based information in a variety of formats that can be consumed and found on the web. Often, consumers search for and engage with information and media supplied by businesses to help them make decisions on the services or products they are seeking. Thus, highly search visible and keyword optimized content not only triggers results in search engines, but also informs and converts the potential customer when it is found.

Subscribers may generate, publish, and syndicate textual content such as, for example, articles, tips, how-to guides, case studies, whitepapers, blogs, newsletters, press releases, ezines, and ebooks. One or more software modules may be configured such that when each piece of content that is loaded or created, a unique search optimized landing page dedicated to that content is generated. In some embodiments, exposure for the content is increased at least in part by providing syndication channels for the subscriber's content along with accessible bookmarking and social sharing functions to the end user. Users of the platform may generate commentary and communication on each unique page and the subscriber may respond, thus providing a mechanism for direct engagement. One or more software modules may be configured to insert meta tags and meta information when each point of content is created. In some embodiments, an intuitive keyword insertion learning system is configured to provide pre-optimized suggestions for meta tags and meta information to the subscriber. WYSIWYG editors may be used to create and manage the various forms of content that the platform can display. An editing tool may eliminate font choices to maintain typography standards. An editing tool may be configured to act as an extension of MS word within a web browser.

In some embodiments, a database of templates relating to various types of content categories and/or business specific documents can be offered to every subscriber on the platform. The templates can be accessed by searching the database and loading the result to the subscriber's toolbox, where it can later be referenced, or during the actual creation process by selecting the content type and having a default template loaded automatically. Referenced templates may open inside of a WYSIWG automatically and without prompting to ensure a smooth experience.

Service partners specializing in content and development and strategy may also be connected to the business through an internal search interface. Templates can also be loaded to the database by contributors on the platform. Subscribers can upload already existing documentation and/or have supporting file formats transcribed automatically into their WYSIWG editor for publishing.

In some embodiments, a method of syndicating textual content may comprise receiving a subscriber's content, formatting the content into a pre-defined template, and preforming search engine optimization techniques. The received content may be further edited by a subscriber. The content can then be formatted for syndication on channels such as, for example, RSS, social media network, newsletter, or other directory. The content can then be distributed to pre-selected channels.

In some embodiments, systems disclosed herein are configured to allow subscribers subscriber to create, publish, manage, and syndicate their products and/or services. The subscriber can create unlimited deals of any type and embed a preexisting ad creative (e.g., previously printed ad in newspaper or magazine), a single photo, or a video to give the offering more depth and information. Each deal created and managed by the subscriber can receive a unique, dedicated search visible page whereby users can access specific information on the business, on the deal, the redemption process, fine print disclosures, reviews, and locations. In some embodiments, each user or registered user that accesses a deal for consumption receives a voucher by email. In addition, information regarding users who accesses a deal may be provided to the subscriber.

Deals may be deleted, edited, changed, or de-listed at any time. The subscriber may be able to re-activate archived deals and thus a subscriber may have running inventory of deals that can be activated or de-activated in response to product overstocking, deeply discounted manufacturer incentives, seasonality, holidays, and many other categories which affect the type and nature of the offering to the public without recreating them. Each newly created deal may be syndicated as desired. In some embodiments, archived or re-activated deals are not re-syndicated unless the subscriber wishes to push that information out to their respective networks. Registered users may capture deals and store them inside of their dashboard, referencing them immediately or at a later time through interior communication directly with the subscriber. In some embodiments, the system is configured to inventory all active deals on either a bi-weekly or monthly basis and blast deals to registered users that have pre-selected or filtered their deal preferences by product, service, and/or geography. The blast may comprise email sent to registered users and may include expiring deals and the new or popular deals in their area.

### Auto-Syndication/Broadcasting

In some embodiments, the platform is configured to provide the subscriber the ability to seamlessly and transparently auto-post content, media, deals, advertisements, general notifications, and other elements to the subscriber's social media channels. Through a variety of integration methods, for example, partnership deals or general API connectivity, the platform may also be configured to update business listing information across local search properties, participating directories, and other channels. While a dashboard and/or admin-interaction page may contain controls for limited customization aspects, the platform may allow subscribers to upload once and syndicate everywhere. In some aspects, content provided by a subscriber to their digital space can syndicate to the subscriber's social channels in a fully automated or partially automated manner. In some embodiments, the platform is configured to accept and push varying data communication protocols such as, for example, gets, http post requests, batch uploading, and general XML integration.

In some embodiments, media content is received from a subscriber. The subscriber may for add, edit, or delete the received content. The content may then be syndicated to one or more of the subscriber's social and/or other third party media accounts. For example, the systems described herein allow for a subscriber to upload a video, edit the video, and syndicate the video to registered accounts for Limelight, YouTube, or any other registered video streams. In another example, subscribers may upload a message, deal, or other E-commerce product to selected social channels from the subscriber's list of registered social channels. The channels may be displayed in the subscriber's dashboard. Subscribers may also view all posts, messages, and/or articles that are syndicated to different social media channels and their respective analytics.

In one embodiment, a subscriber can create a policy for content syndication by choosing from the tools available in a syndication tool kit. The tools may allow a subscriber to control how and to who the content is distributed to. For example, a subscriber may create one content policy that publishes to certain specific social media sites the subscriber is registered with and another policy that publishes content to every social media site the subscriber is registered with. The subscriber may then upload content and select the policy. The content is then syndicated according to the policy.

A method of distributing content may comprise receiving content from a subscriber. A content syndication and broadcasting engine or module may receive the content. The engine may then create a set of questions that are displayed to the subscriber according to the broadcasting channels that the subscriber has provided. The questions may include a list of syndication channels available to the subscriber. The engine may also provide format suggestions for the subscriber to consider according the channels. The engine may create a specific format that needs to be satisfied and/or extract information required by each channel. The engine may then display previews of the syndicated content. The engine may prompt the subscriber for approval of the previewed syndicated content. The engine can then syndicate the content to the selected broadcasting channels based at least in part on the answers received from the subscriber. In some embodiments, a subscriber submits a third party API as a broadcasting channel. The request may then be provided with the API which is further analyzed by the administrator and then approved for the use. On approval the API may be displayed on the subscriber's channel list. The channel list may be displayed as a portion of a subscriber's dashboard.

In some embodiments, the platform includes one or more software modules configured to publish content from another website using RSS in a subscriber's digital space. Subscribers may search for RSS feeds available on the web. The subscriber may then select the RSS feeds of interest. The selected RSS feeds are then automatically displayed on one or more pages of the subscriber's digital space.

In some embodiments, the system is configured to connect with a plurality of content distribution channels. Thus, the system may implement standardized data communication formats (for example, batch processing, FTP, XML, HTTP, POST, or GET) or accessing and integrating various API's. In some embodiments, the system includes a library containing all third party API, internal API, and information gathered using custom protocols in one unified display for a user to interact with. In some embodiments, the system may be configured to identify potential channels for and suggest the most relevant channels to subscribers. In other embodiments, the system includes an internal API product. The system may be configured to transmit media and/or information from a subscriber's digital space to channels such that the information is standardized per individual channel selected by a subscriber. Account creation and management functions for distribution channels may be integrated through oAuth and/or oneID. In some embodiments, the system will automatically supply a subscriber's email, password, and/or code verifications to the distribution channels. In some embodiments, the system will display the code verification for distribution channel on the dashboard or dedicated page of a subscriber when the subscriber pushes content to the distribution channel.

In some embodiments, one or more software modules may prompt a user for answers to questions designed to determine the desired geographic/demographic reach of the subscriber's business objectives, products, and/or services. Such questions or prompts may be displayed to the subscriber when the subscriber registers or periodically over time. Modules may receive the information and based at least in part on the information received to the questions, provide suggestions to subscribers and/or automatically create connections between subscribers and the most relevant and effective local or national channels available. Such channels may then be populated within a subscriber's dashboard. In some embodiments, each channel listing includes embedded linkage that will display, for example, the subscriber URL's, a preview of the channel's display, a description of selected a selected channel, video or contextual information regarding how the channel may be effective, and what content may get posted to that account using, for example, the OAuth and/or OneID.

In some embodiments, the platform can act as the overriding logic within the API integration for participating social networks. This may allow a subscriber to create branded experiences as an extension of their digital space. The platform may also contain logic components for managing the launch and integration of, for example, the subscriber's landing pages, contests, forms, surveys, games, maps, animations, and other subscriber customizations. Many social networks allow a developer to create a prefabricated template consisting of HTML, CSS, and/or Javascript elements. Such templates can be layered into, for example, a facbook tab, twitter homepage, YouTube account, and/or Google+ account associated with a subscriber. Thus, in some embodiments, the platform is configured to recreate, for example, the navigation elements, pages elements, media elements, page structure, engagement structure, conversion structure, branding, and graphical elements that are loaded to a subscriber's digital space on other social platforms and/or other networks.

The platform may be configured to recreate, for example, the navigation elements, pages elements, media elements, page structure, engagement structure, conversion structure, branding, and graphical elements that are loaded to a subscriber's digital space on the subscriber's pre-existing webpages accessible through pre-existing URL's. The platform may also be configured to recreate, for example, the navigation elements, pages elements, media elements, page structure, engagement structure, conversion structure, branding, and graphical elements that are loaded to a subscriber's digital space on a website (see, e.g. the Subscriber's website in FIG. 3) hosted by a subscriber's own server and/or a third party server. This goes beyond conventional website building tools as the content used to populate the separate subscriber website is at least partially content that is already available to internet users on the digital space. Very simple menu driven interaction by the subscriber can be used to configure their website. Furthermore, when multiple subscribers of the platform are controlling their website content from the digital space, link sharing between subscriber websites is simplified, and can also be handled by a menu driven process on the different subscriber's digital space dashboards. Such link sharing is very effective at increasing search engine visibility and the search result rank of content of each subscriber's website to the major internet search engines.

For example, in some embodiments, a user may discover a subscriber on the subscriber's facebook page. Thus the user may consume subscriber information and media from within the facebook setting first. If the user wishes to visit the subscriber's digital space from facebook, one or more links to one or more pages of the subscriber's digital space may be provided. Such links may be provided automatically through the syndication of content on the digital space that is then pushed to the subscriber's facebook page. The system may utilize the techniques described herein such that the look and feel of the facebook page corresponds to the look and feel of pages in the subscriber's digital space. In this way a subscriber's branding, media, messaging, experience, and public face of the company remains consistent across platforms. In addition, the consistency provides a user confidence that the subscriber's facebook page is professionally aligned with other pages on the web pages on the subscriber's digital space.

In some aspects, the platform may contain templates designed for a subscriber's social account homepages. Thus, the platform may include a content management system configured to allow the subscriber to personalize the navigation, color schemes, graphic elements, media elements, fields, forms, and content of the template. Such templates may be archived and accessed by subscribers for use in reoccurring campaigns, seasonal changes, and/or contests. In some embodiments, subscribers may create their own templates. Such templates may be loaded and accessed in the subscriber's dashboard for activation or archiving.

In some embodiments, for example, where a subscriber has a pre-exiting product database including imagery, pricing, accompanying media, and/or ecommerce structure, the platform may be configured to recreate and display such database in a consistent manner within the subscriber's digital space and across social media and/or other distribution platforms.

For example, digital spaces that are directed toward ecommerce may be syndicated to, for example, eBay, Amazon, etsy and other similar ecommerce platforms in a consistent manner.

### Search Engine Optimization

In some embodiments, content that is uploaded by subscribers to their digital space is embedded in optimized search visible pages. In some embodiments, subscribers receive suggestions from one or more software modules to improve search results. As such, one or more software modules may be provided to increase the discoverability of published content through at least partially automated search engine optimization tools. In some embodiments, media and/or content pages include optimized page structures that are standardized for optimizing search engine discoverability, social sharing, and RSS. Embedded Search Engine Optimization (“SEO”) and Social Media Optimization (“SMO”) may provide a cost effective way for a subscriber, such as a local business, to be found and engaged by customers. SEO and SMO can include, for example, meta-tags, OG-tags, GEO-tags, minify-tags, micro-tags, sprites, rel-tags, include tags, relative path tags, social plug-in tags, and/or share button tags. For example, when a subscriber designs their digital space, one or more software modules on the platform can increase the discoverability of the pages of the digital space by, for example, automatically creating the page titles, informative URLs, populate description meta-tags, add the subscriber's location(s) to Google places, and/or manage sitelinks. In some embodiments, such data is automatically extracted from the content and populated as micro formats into unique page code. As is well known, micro formats are standardized markups that may be associated with web page information to denote the nature of particular pieces of information on the page. There are many different micro formats specific to different industries and data types. The platform may store large numbers of such formats for use when assembling micro format semantic markup for uploaded subscriber content. The platform may combine information about the different micro formats with industry or other information provided to the platform by the subscriber for appropriate selection of micro format markups when processing uploaded content from each subscriber.

In some embodiments, one or more software modules may be configured to measure factors that contribute to a website gaining a response in a search engine for user generated queries. Such modules may allow subscribers a means of integrating measurement and analysis of their already existing web properties. A comprehensive view of traffic, user behavior, triggered keyword responses, conversion points, and other metrics may be displayed to a subscriber. Each subscriber created channel, digital asset, media distribution, social interaction, and conversation can be monitored and analyzed for visibility and discoverability. Some embodiments include an integrated analytics dashboard for displaying, sorting, and analyzing such metrics.

In some embodiments, one or more software modules are configured to receive information relating to a subscriber. Such information may include, for example, a subscriber's business type, industry, specialty, category, and/or geographic location. The module(s) can be further configured to determine a list of keywords based on the information received from the subscriber. The module(s) can then insert keywords and/or or meta tags based on the information into content pages created by the subscriber. One or more software modules may include data mining algorithms that can extrapolate the importance and relationship of specific keyword terms based at least in part on the information provided by subscribers on the platform. Such these relationships may be delivered and/or displayed to subscribers in real-time. For example, software modules can suggest keywords and or meta tags more accurately by monitoring previously uploaded content on the platform, API integrations, search engine, and social media interactions. In some embodiments, one or more software modules are configured to continually measure and analyze content and keyword relevancy within the platform and/or connected social media accounts and/or industry specific external webpages. Thus, in some embodiments, the system can auto-suggest industry specific relevant keywords to subscribers.

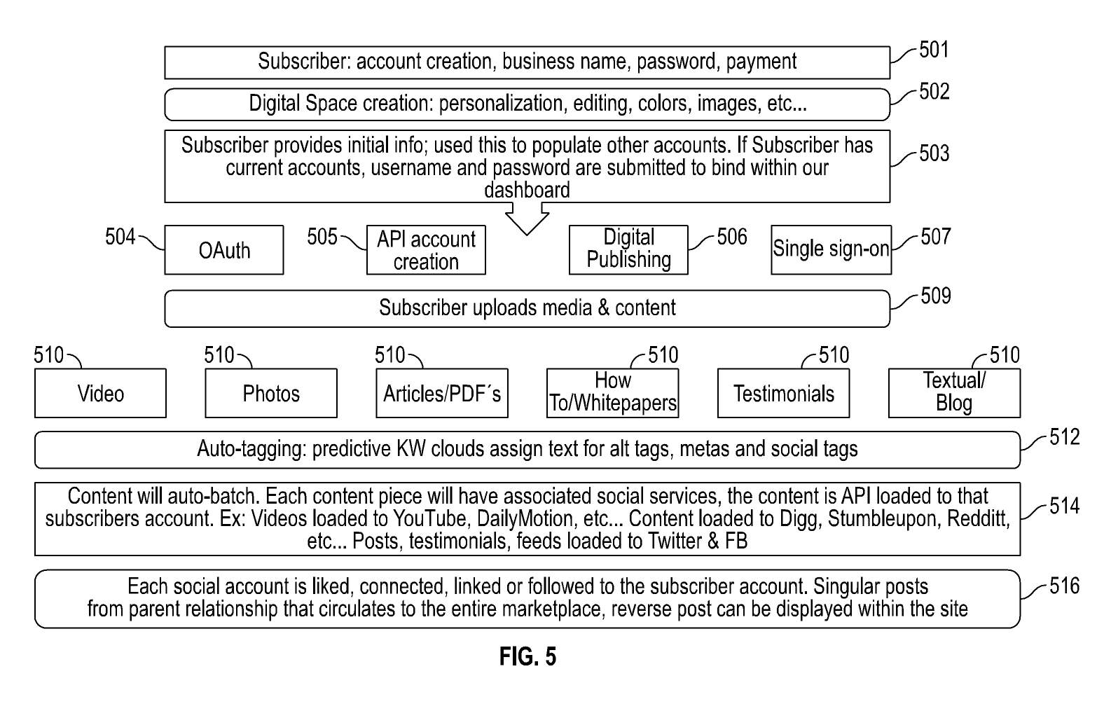

With reference to FIG. 5, an example block diagram according to one embodiment of a process flow for distributing content to from a subscriber's digital space is illustrated. A subscriber can create an account on the platform at 501. The account on the platform may require that a subscriber's name, password, contact, and payment information be provided. A subscriber may then at least partially customize the look of the digital space at 502. The subscriber may then provide account information for social media and/or content distribution sites at 503. A subscriber's dashboard may then be used to access other server resources, create API accounts, publish content, and sign-on to multiple sites with a single sign-on. Subscribers may upload content at 509. Such content 510 may include, for example, videos, photos, articles, whitepapers, testimonials, and or blog postings. The content may then be tagged automatically at 512. The automatic tagging may be performed by one or more software modules and may include the use of a predictive keyword cloud based engine that assigns texts for alt tags, meta tags, and/or social tags. The content may auto batch at 510. Content may be associated with social media services selected by the subscriber. The content may then be API loaded to a subscriber's social media accounts. The social media account may then be linked to the subscriber's digital space at 516. Posts made on the social media account may be captured and displayed on the subscriber's digital space.

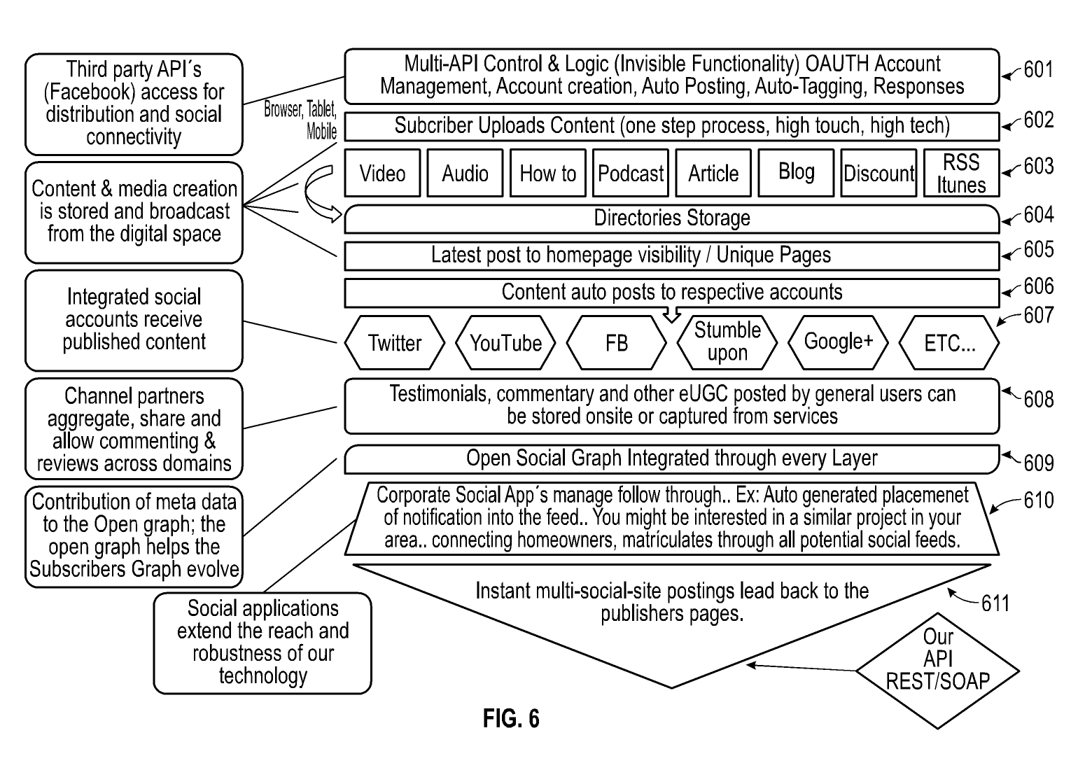

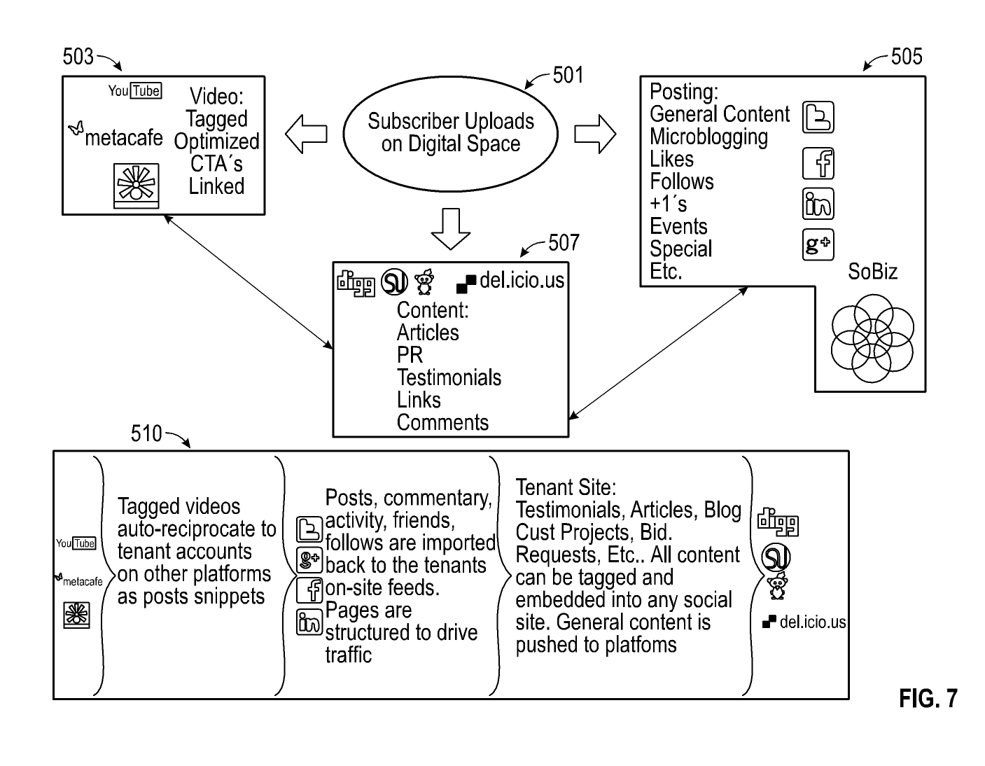

FIGS. 6 and 7 shows example a high level block diagrams illustrating the syndication of content from a subscriber's digital space. As shown in FIG. 6 the platform may provide multi-API control, allowing the management of multiple distribution channels at 601. Subscribers may upload content at 602. A variety of content forms 603 are supported. The uploaded content may be stored in a directory at 604. Each upload may create a unique webpage that is linked to a subscriber's homepage at 605. The unique webpage may be displayed as a preview or link on the subscriber's homepage. The uploaded content may then be automatically posted to the user's distribution accounts at 696. A plurality of distribution channels 607 may be supported. Users may interact with the content distributed to the distribution channels at 608. Such interactions may be captured from the distribution channels and stored on a database at 608. Such interactions may then be analyzed, managed, and displayed to the subscriber at 609. In some embodiments, a plurality of subscribers may post to the same distribution channel. Thus, in some embodiments, reports may be generated not only for the subscriber but also for the subscriber's parent account consisting of multiple subscribers. Subscribers may be notified of interactions with published media at 610. Content that is posted through distribution channels may include a link that routes viewers of the content back to the subscriber's digital space.

Turning to FIG. 7, the platform may recognize a subscriber's content type and then automatically distribute the content based at least in part on the content type and/or pre-existing preference information received from the subscriber. Thus, the digital space may operate as a CMS (Content Management System) that provides automated syndication and distribution based on pre-existing subscriber choices about which of multiple alternative destinations different types or other categories of content should be distributed to. Conventional CMS software does not provide this functionality, requiring each piece of content to be handled individually. The pre-selection may be menu driven through a user interface provided as part of the digital space of the subscriber.

The process may begin at 501 when the subscriber uploads a piece of content. The platform may recognize the content as video at 503. The video may then be automatically SEO′d by, for example, tag insertion, additions of specific calls to action, and/or embedded links. The video may then be distributed from the platform to a plurality of channels. Embedded links may link to other content located either on the subscriber's digital space and/or on other distribution channels. Similarly, textual content may be automatically recognized, SEO′d, and distributed at 507. Social media content may be recognized and distributed through social media channels 505. In some embodiments, a plurality of subscribers operate under a parent account. These subscribers may upload and syndicate content on behalf of the parent account. In these embodiments, all of the content uploaded may include at least one link to a page in the digital space of the parent account. Thus, traffic is driven by subscribers to the parent's digital space.

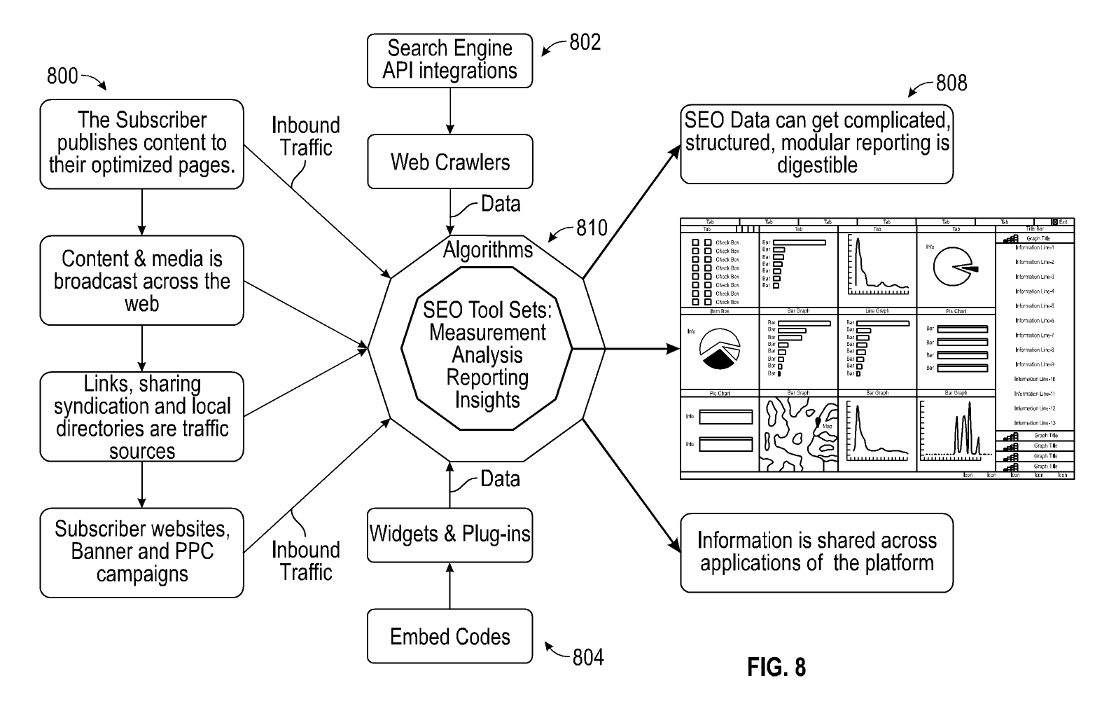

FIG. 8 shows an example block diagram illustrating one embodiment of a search engine optimization analysis tool. All inbound and outbound traffic to the platform may be monitored and recorded. Subscribers may drive traffic to the platform at 800 by publishing content to their digital space, syndicating the content, sharing links to their digital space, and/or providing links to their digital space through banner advertisements and/or other websites. One or more webcrawlers may also supply data to the platform at 802. Brower plug-ins and/or widgets may also supply data to the platform. Such data may then be processed and made available to subscribers to the platform. In some embodiments, reports are displayed to subscribers relating to the amount of traffic their digital space has generated. In some embodiments, the data is used to provide suggestion to subscribers relating to way to increase traffic and further optimize their content distribution policies.

### Communication Management System

In some embodiments, a subscriber's dashboard may include a communications management system comprising an integrated messaging management area. The integrated messaging management area may comprise one or more software modules configured to manage, display, and interact with subscriber to subscriber, subscriber to consumer, and consumer to subscriber communications. In some embodiments, the communications management system also provides a subscriber notifications, contests, and gameification related elements. Additionally, software applications running on top of the platform that require communication features can also interact within the communications management system.

In some embodiments, the communications management system is configured to operate as an email client-type interface having the ability to order, search, respond, and flag various communications within the platform and between other platforms on the web. The communications management system may be configured to be integrated with exterior mail providers such as Gmail, Zoho, iCloud, and/or marketing services such as Constant Contact, Mail Chimp and iContact.

In some embodiments, the communications management system is configured to capture data from incoming and outgoing communications. The communications management system may also be configured to display to the subscriber information, such as, the number of page views, store front views, article/video/photos views, likes, comments, the amount of shared content, and/or flagged content, and/or the number of sales or deals accepted by users. The communications management system can also be configured to send messages to registered users and/or subscribers and/or mailing lists in an automated manner.

In some embodiments, the platform is configured to provide users and/or subscribers interfaces with existing services such as Google docs, prezi, dropbox, evernote, zoho, open office and a host of other available applications. In addition, the platform may be configured to provide users and/or subscribers interfaces with financial, accounting, payroll, and/or invoicing tools such as quick books and/or zoho. The platform be configured to provide users and/or subscribers interfaces with presentation solutions, calendar tools, and/or task management tools. Thus, a subscriber and user can access a multitude of available functionalities on the web from one location. Such tools may be accessible to subscribers via their dashboard.

### Social Media Engine

Some embodiments include one or more software modules configured to centralize a subscriber's API connectivity credentials, FTP accounts, and other data transmission protocols for communication and manipulation of exterior syndication channels. The modules may be configured to capture every post and response on the subscriber's syndication channels. Such post and response may include, for example, comments, user reviews, subject discussions, tweets, and/or responses. The modules may be configured to automatically post a subscriber's media to their respective syndication accounts. Such social publishing modules may be configured to distribute and embed content generated on a subscriber's digital space to the subscriber's social accounts and/or profiles.

In some embodiments, the Social Media Engine is configured to automatically incorporate and utilize web based protocols for OAuth 1.0 & 2.0, SDK's, API's, REST, SOAP, XML & JSON standards. This flexibility may allow for the addition, modification, or subtraction of any emerging network or change in network protocols without recoding or interrupting the experience of users and/or subscribers.

Media previously published by the business entity may act as a categorized library that is accessible to any of the linked social networks. Thus, with a single click such previously published media can be embedded into any messaging component or social marketing campaign and the system can generate an automated URL specific to where the media is originally hosted as a web page within the platform directory. The social media engine may be configured to listen, measure, track and report on metrics, information and insights obtained from user based interactions, subscriptions, redemptions and commentary gathered from the original distribution points.

For example, in some embodiments, one or more software modules may be configured to capture conversations and/or commentary occurring around each piece of media posted by the subscriber from other platforms. In some embodiments, the one or more software modules are configured to manage multiple networks through a single common protocol. Thus, a subscriber may be able to view and monitor responses to social media syndication from a central page. The page may be accessible to the subscriber and contained in the subscriber's digital space on the platform. Subscriber responses may be generated from the subscriber's digital space and posted to, for example, a social network of other syndication channels.

In some embodiments, one or more software modules are configured to gather and analyze syndication information. Such modules may, for example, monitor all social interactions from the subscriber's digital space. These interactions may be gathered and displayed to a subscriber in a sortable format allowing the subscriber to, for example, sort interactions by category, media type, industry type, geographic location, and/or keyword(s). In some embodiments, the subscriber's dashboard can be used by subscribers to view social media analytics. Some embodiments include a news feed like display listing content that may be filtered by one or more logical filters. Such filters may include, for example, syndication channel filters, network filters, date or time period filters, user filters, type of content filters, and/or location filters. In some embodiments, the news feed is color coded for the source of the information. In some embodiments, the top comment in each thread received to the digital space may be expanded to display the entire conversation and/or linkage. Subscribers may be allowed to delete, respond to, and/or posting content directly from the digital space to the syndication channel. A messaging center may be provided allowing a subscriber to manage the syndication channels from multiple areas of the dashboard interactive display. The dashboard may include an interface to allow a subscriber to search, for example, posts and comments which may be stored inside of databases designed to easily parse massive amounts of information with speed and efficiency. In some embodiments, meta tags are integrated into the page code so that when a subscriber shares content or when the subscriber syndicates content to social networks, the subscriber's digital space remains the prevalent point of origin.

In some embodiments, one or more software modules can be configured to collect data related to social media posting and reactions to such postings. This collected data may be used by a subscriber to analyze the effectiveness of the subscriber's syndication and social media presence. The data may be sorted and displayed to the subscriber.

In some embodiments, a method for at least partially automating the syndication of content from a subscriber's digital space may comprise the creation of a media element within a subscriber's digital space. The creation of a media element within a subscriber's digital space may comprise the generation and publication of a unique search engine visible landing page. The landing page may be linked to other pages of the subscriber's digital space, other subscriber's digital space, registered user's digital spaces, or any other web page available on the internet. Registered users may similarly syndicate content.

After the unique search engine visible landing page is created, the system may automatically push information to selected subscriber accounts across the web. Some embodiments utilize the integration of supported single log-on technology such as OAuth and OneID to facilitate a superior experience and reduce complexity of logging into subscriber accounts. In some embodiments, if a viewer of the information on the account interacts with the subscriber's posting, the information is retrieved by the system and displayed on one or more pages in the subscriber's digital space and/or dashboard. The system may include an API handling level module configured to transform the posted media for each distribution channel's particular restrictions. The system may also include one or more software modules configured to access metric data that may be supplied by major social sites. This information may then be returned, displayed, and analyzed in the subscriber's dashboard.

In some embodiments, the system may prompt a subscriber to sign up and create an account on one or more social sites or distribution channels that the subscriber has not yet signed up for. One or more software modules may be configured to receive information about, for example, the subscriber's business, industry, category, location, specialty, customer base and provide new account recommendations to the subscriber. In some embodiments, an IFrame may be located within the dashboard that automatically opens a window for accessing the sign-up process for particular site. In other embodiments, for sited that do not support API connectivity for example, the system may supply its own API credentials.

In some embodiments, the platform is configured to receive registrations of registered users. Registered users may then be able to leave comments on the platform, for example, registered users may leave comments on a subscriber's digital space or pages thereof. Registration may occur through numerous ways. For example, registration may occur during an opt-in capture process when a user accepts a deal voucher, or registration may occur when a user contacts a subscriber, or registration may be prompted for when a user comments on a subscriber's social channel. Registration of users may include integration of OAuth and/or OneID technologies.

Reviews and/or comments by end users regarding specific pieces of content and/or media published by the subscriber and/or reactions by end users to products and/or services provided by the subscriber can help drive the subscriber's sales and exposure. In addition, many search engines place a great deal of weight on end user reviews. Thus, user reviews and comments on a subscriber's digital space can further increase the visibility of the digital space by search engines and/or improve search results rankings.

In some embodiments, registered users may have a dedicated page in their own digital space that can place orders from subscribers, retrieve and view subscriber information, and/or track the registered user's interaction with both a subscriber's content, and other registered user's on the platform. For example, in some embodiments, every review or comment that a registered user leaves on the platform is logged and displayed in a dedicated page of the registered user's digital space. From here, the registered user may, for example, view and follow threads of responses and/or conversation generated around the review or commentary of the registered user and/or leave additional feedback should they desire. Registered users may also be able to bookmark relevant content that they encounter on the platform.

In some embodiments, subscribers will have all deposited reviews and commentary integrated into the subscriber's messaging center. The subscriber may then respond to each registered user individually or within the conversion of a group of registered users. Through visual edit modes, for example, the subscriber may also respond to comments and reviews from within a dedicated page of the subscriber's digital space. All responses that are generated to content, comments, and/or reviews can be logged and recorded to the registered user's dedicated page as well. In some embodiments, all reviews and/or comments left on pages of a subscriber's digital space or social media/distribution account channels may be archived to a dedicated page of the subscriber's digital space and/or within a section of the subscriber's dashboard.

In some embodiments, both subscribers and registered users will not be provided the ability to delete comments. In such an embodiment, comments and/or reviews may be disputed through an internal dispute process mediated by administrators of the platform. Some embodiments include a notification field where both registered users and subscribers can flag the content and ask for resolution. Comments and reviews may be automatically filtered for cursive language and offensive content and the system can be configured to deny postings that contain such information.

Subscribers may also be able to aggregate reviews from other platforms and web sites through one or more software modules of the platform. For example, reviews generated through yelp, Google, facebook, twitter and other sites can be captured and imported to the and displayed in a subscriber's or registered user's digital space. In some embodiments, each such review is tagged with information relating to the site where the review was originally posted.

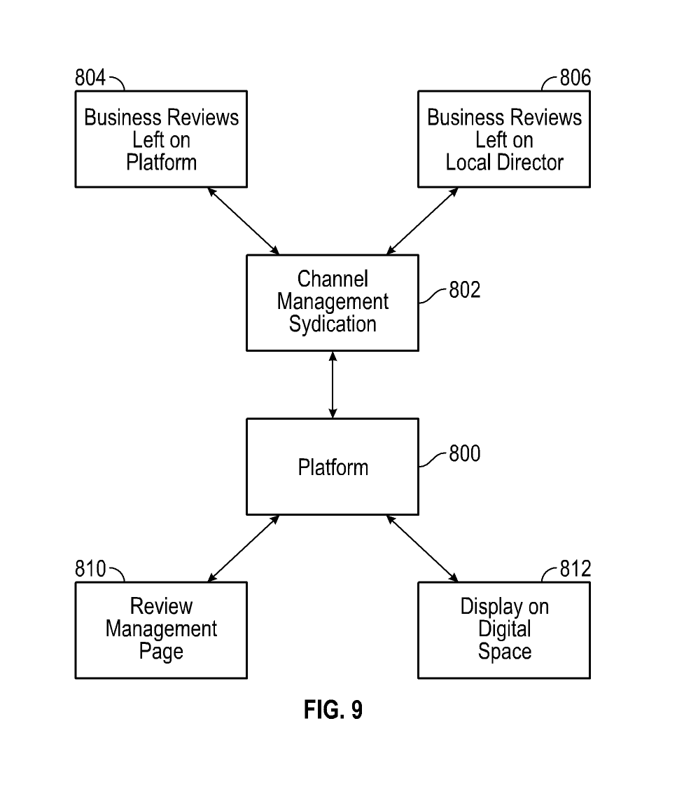

Turning briefly to FIG. 9, the platform 800 may include a channel management syndication engine 802. The channel management syndication engine 802 may retrieve and/or store reviews and/or comments that are posted on the subscriber's pages that are on the platform 804 and retrieve and/or store reviews and or comments that are posted on the local directories of the subscriber's channels 806. The review and/or comments may be displayed and managed by the subscriber on, for example, a review management page 810 that is available to the subscriber. All reviews and or comments may also be displayed to users on the subscriber's digital space 812.

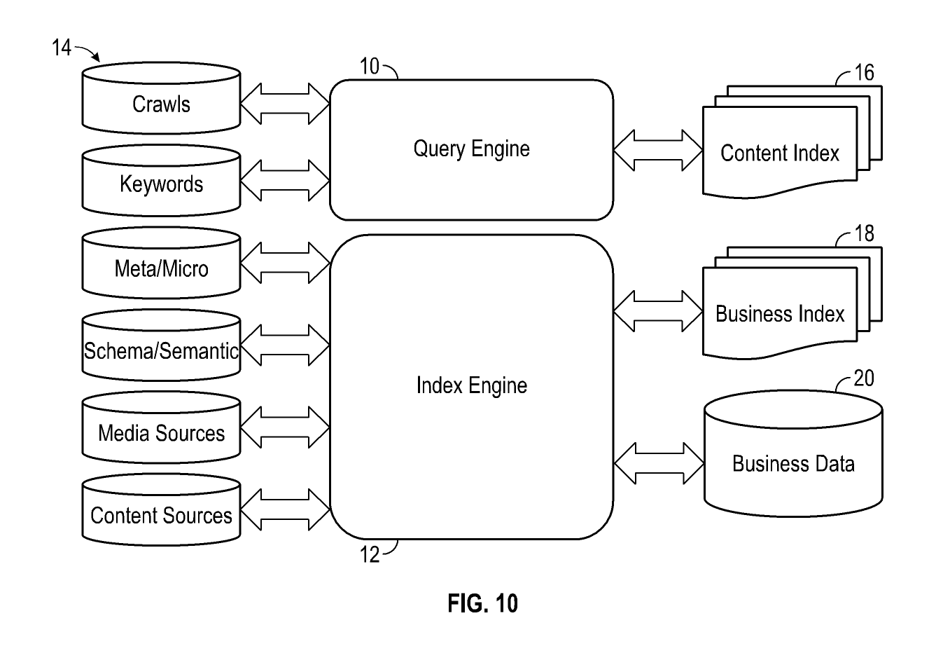

In some embodiments, the platform includes one or more software modules configured to index each subscriber's content on the platform. Such indexing data may be shared with third party search engines. The indexing may standardize the information available on the platform. As shown, for example, in FIG. 10, a query engine 10 and an index engine 12 may gather data from sources 14 such as web crawlers, keyword searches, meta and mirco tags, shema/semantic structures, media sources, and content sources. The query engine 10 may search for keywords and then populate a content index 16. The context index 16 may display results of keyword searches by users and/or subscribers. The index engine index the platform and create a business index 18 that may be searched and may compile business data 20.

### Ecommerce

In some embodiments, a subscriber's digital space may include at least one page for the sale of products and/or services. Such pages may have the same unique and dedicated search optimized structure as other media pages within the digital space, but with the distinction of being focused towards creating exposure and distribution for products and/or services. The platform may include an ecommerce based system that is Payment Card Industry (“PCI”) compliant. Thus, in some embodiments, one or more pages of subscriber's digital space are configured to accept and process payments from users. In some embodiments, a user's digital space may interact with third party web site APIs to provide an e-commerce APP to the subscriber ecommerce and/or virtual storefront pages.

In some embodiments, the platform may include one or more software modules configured to syndicate product related content to social networks and ecommerce platforms such as Amazon, eBay, Etsy, Googlebase and others. The subscriber may be able to manage the experience, inventory, design, marketing, transactions, financial processing, shipping fulfillment, customer management, and more in an integrated manner that may be displayed in the subscriber's dashboard. In addition, the platform may capture, measure, and store metric and meta information relating to all sales the transactions, products, customers, sales and customer locations, previous purchases, pricing, demographics and other areas. Such information may be sorted, displayed, and analyzed using the subscriber's dashboard and/or displayed on a dedicated page on the subscriber's digital space.

In some embodiments, the platform is configured to enable subscribers to create, edit, manage, launch, measure, and/or processing a marketing campaign that interacts with social media, SEO, PPC, ad networks, gameification, drip email, and any other channels available to the subscriber. Such a marketing tool may be available on the subscriber's dashboard. The marketing tool may allow for the subscriber to tailor a marketing campaign by selecting uploaded content to be syndicated, selecting the time and date the content will be syndicated, and selecting the channels that the content is syndicated to. One or more modules may then distribute the selected content according to the subscriber's input. In some embodiments, a subscriber's database of uploaded content may be searched and navigated with a script driven framework that floats within the interface. A subscriber may then select content generated by that search for insertion into any campaign or campaign template. Thus, in some embodiments, a module accessible through a subscriber's dashboard is configured to organize, automate, and synchronize a subscriber's marketing campaign and is included within the platform. In some embodiments, one or more software modules can be configured to extract product information from a subscriber's pre-existing ecommerce pages or information. This module may then replicate this information on unique pages on the subscriber's digital space and/or throughout other social networks enabling multiple purchasing options for users.

### Analytics

In some embodiments, one or more software modules may be configured to measure and archive data generated by traffic, conversions, behaviors, consumption, and the interaction of users and subscribers on the platform. Data may also be acquired from interactions with social channels, local searches, third party web sites, media views, products views and sales, and/or every element that generates conversation on the platform. The data may be stored in databases and be retrieved in in response to specific queries. Such data may be accessible by subscribers.

One or more software modules may be configured to sort, analyze, compare, and display the data to subscribers. In some embodiments, the data may be accessed and displayed through a dashboard product located inside of a subscriber's administration area on their digital space. Data may be displayed graphically. Data mining modules may be configured to extrapolate unique subscriber opportunities tailored to each subscriber. Data may be used by subscribers for marketing, client targeting, and/or or research purposes. In some embodiments, data mining modules are customized for each industrial category, sub-category, and/or geographic location.

Some embodiments include an interaction engine configured to capture conversions, behaviors, consumptions, and interactions among the users and/or subscribers on the platform. The captured data may be stored and accessed by one or more software modules configured to supply custom analytics for each subscriber. Some embodiments include a social interaction engine configured to crawl all the information that is shared between a digital space and other websites. Such information includes, for example, information shared with social media, comments, and/or testimonials. In some embodiments, the system uses the interaction and social interaction engine to supply each subscriber with a detailed report on the data that has been exchanged on and through their digital space. In addition, the platform may utilize third party tools such as Google analytics, quantcast, cookies, and search crawlers to gather and supply additional information to subscribers in a centralized location.

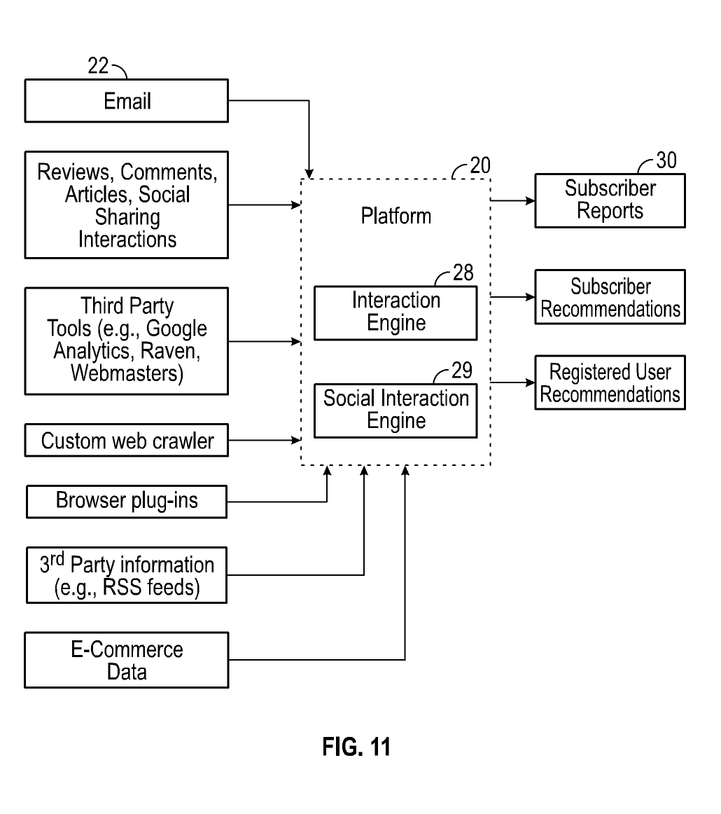

As shown in FIG. 11, the platform 20 may include an interaction engine 28 and a social interaction engine 29. In some embodiments, only one engine is used that functions both as the interaction engine 28 and the social interaction engine 29. The engines may search for, archive, and sort relevant information from all interactions hosted by the platform. Sources of data 22 may comprise incoming and outgoing email, reviews, comments, or other social media interactions with content syndicated by the platform, tools available from third parties, custom webcrawlers, browser plug-ins, third party content, and/or ecommerce data. The engines may then use the data to create and display outputs 30 such as, for example, subscriber reports, registered user reports, and subscriber recommendations.

### Gamification

In some embodiments, the systems and methods disclosed herein may include gamification elements configured to provide one or more rewards to subscribers and/or users. In some embodiments, rewards are provided when a pre-determined level of activity is satisfied and/or achieved by the user and/or subscriber. Gamification elements may be used to motivate and/or incentivize users and/or subscribers to use all of the platform tools by rewarded users and/or subscribers with credits and/or incentives

In some embodiments, the platform may allow for a subscriber to develop and/or deploy contests and/or games on their digital space and/or on pages or tabs within social networks. This may include, but is not limited, to social networks such as YouTube, facebook, twitter, pinterest, and other similar platforms and sites. Thus, the platform may include one or more CMS features configured to create content parameters and/or capture forms, display interactive elements, details, graphics, links, and/or media submissions, incorporate meta-tags and other components, and embed and display such components in a landing page on the subscribers digital space. Landing pages may be generated in HTML5 and/or CSS3 formats to ensure that the pages are displayed consistently in the mobile setting. Such landing pages may also be broadcast to the subscriber's network of channels just like any other piece of content to provide additional exposure. Templates for many types of contest and/or sweepstake related structures may be available to subscribers.

In some embodiments, landing page creation can be accessed by an icon located inside of a subscriber's toolbox. The landing page may include dedicated URL logic and interconnectivity with the widget section to embed contest interfaces on other blogs or sites that do not support API integration. One or more software modules may be configured to capture data relating to games and contests and the tracking/reporting for each type of contest may be displayed to the subscriber.

In some embodiments, subscribers and/or users may be rewarded for completing a game, survey, or contest by receiving a link to the subscriber's and/or users digital space. In some embodiments, games, surveys, or contests may only be available to registered users thus providing incentive for user's to register with the platform.

In some embodiments, subscribers and/or users may receive points of creation within the platform in response to completing and/or creating content in their digital space. For example, subscribers and/or users may receive points of creation within the platform in response setting to the user and/or subscriber up a storefront, uploading content, following up with marketing activities, and/or creating a contest. Such points may be used to provide rewards to users and/or subscribers and may be designed to help the user and/or subscriber create a more comprehensive digital space and may also simultaneously train the user and/or subscriber how to use functionalities provided by the platform.

In some embodiments, when a gamification type campaign generate a response form a user and/or subscriber, the platform may capture and such responses through lead capture notifications, information insertion, social reporting metrics, email notifications, and/or mobile push notifications. Such data may be analyzed and displayed the subscribers. Data may include, for example, the number of times a is game played, the number of times a contest is entered, conversion points achieved, time spent using the game, number of social media shares, number of emails linking to the game, number of signups for newsletters, etc. Subscribers may manage gameification related functions within their dashboard. In some embodiments, campaigns created by a subscriber are automatically syndicated and linked though channels selected by the subscriber.

In some embodiments, a subscriber can select from contest templates such as giveaways, sweepstakes, fire sales that may be displayed to the subscriber the dashboard. Such contests may incorporate and/or link to content that was previously uploaded by a subscriber. In some embodiments, contests may be designed to increase the visibility of other pages on a subscriber's digital space. For example, the completion of a contest may result in displaying a product page of a subscriber's digital space and/or an offer of the product at a discounted price.

Logical Layers

In some embodiments, the platform includes unified database level control for multiple layers of complex logic. Thus, the platform may be configured to allow platform administrators to edit, add, or remove every feature and/or process available to subscribers and/or users. As such, platform administrators may, for example, alter available search parameters and logic, change the display logic, edit media values for gameification elements, alter the overall navigation site logic, and adjust all algorithms pertaining to analytics, intelligence, API development, AI, and ad management.

In some embodiments, the platform may include separate databases for each industry as well as a master database that controls overall knowledge of all databases and/or acts as controller to route each request to a relevant database. In some embodiments, subscribers may filter results based on industry and/or geographic location. Storing industry specific information on separate databases may reduce bottlenecks and increase the speed of displaying relevant information to users and/or subscribers. Some embodiments include a business logic class that can allow for relevant industries to be identified and sorted quickly.

### Embedded Widgets

In some embodiments, the platform may be configured to allow subscribers and/or users to embed widgets into their digital space. Widgets may comprise one or more software modules configured to enable transmission of content, streams of data, and/or other functions that can enhance the ability to display information to a subscriber's and/or user's digital space from another website or application and vice versa. In some embodiments, a subscriber may access a cache of widgets configured to facilitate the embedding of content from their digital space to other websites. For example, in some embodiments, a widget may be configured to allow podcasts to be uploaded to the subscriber's digital space and streamed from another website that may not be on the platform. Social features, sharing, connectivity, and engagement aspects may be integrated within every widget. By providing widgets that can be plugged into a CMS architecture, subscribers may re-create the same experience they crafted within their digital space on one or more other websites that may or may not be located on the platform. For example, a subscriber may use such widgets to make the content uploaded to the digital space available on the subscriber's company website. In some embodiments, content amassed on a user's/subscriber's digital space may be condensed into a stream that may be delivered to newly created CMS pages on independent websites. In some embodiments, registered users may capture a subscriber's widget and embed the subscriber's content directly into the registered user's dashboard and/or pages on their digital space.

### Browser Plugins

Some embodiments include one or more browser (for example, IE, Chrome, Firefox, Safari) plugins configured to track user and/or subscriber behavior on the web including, for example, location information, search keywords, product or service discussions, time and date information, and additional context information for interactions with other websites and websites on the platform. Such data may be stored and utilized by one or more analytical software modules. The browser plug-ins may also be configured to interface with a subscriber's/registered user's dashboard, allowing users and subscribers to bookmark, capture, find, embed, track and share information from not only the platform itself, but the web in general. One or more software modules may be configured to sort such information and media and provide suggestions to subscribers and/or users in order to facilitate their consumption and/or purchasing objectives. One or more software modules may also use information gathered by the plugins to create advertising that is displayed to registered users. For example, a browsing pattern advertisement module may be configured to provide relevant advertisements to registered users based at least in part on to the registered user's browsing pattern obtained by the plugin.

### Service Partnering

Some embodiments include an internal directory/search tool designed to facilitate introductions to products/services that subscribers may offer to each other. Such an affiliation directory may be populated automatically by one or more software modules that may add subscribers to directories based industry type, sub-type, and or geographic location. In some embodiments, subscribers may manually add themselves to one or more affiliation directory manually. Affiliation directories may be referral driven and/or require permission from an administrator or a majority of subscribers already listed in such directories. In some embodiments, subscribers are required to supply a payment and/or documentation in order to be listed on certain affiliation directories. In some embodiments, subscribers may be automatically added to an affiliation directory based at least in part on a rating system.

Subscribers to the platform may be able to launch a search interface configured to find related subscribers. Subscribers may tag other subscribers and add the subscriber's information into their digital space. Subscribers may also identify subscribers in other geographic areas and link to other subscriber's digital spaces on other websites to provide referrals. In addition, the creation of links between subscriber's digital spaces and external websites can increase search engine discoverability and improve search ranking results. Because subscriber's digital spaces are contained on the same platform, links between subscribers may be created quickly and efficiently.

### Mobile Applications

In some embodiments, the platform may allow subscribers to offer applications for download to users. Such applications may be downloaded and installed on a user's mobile phone. In some embodiments a mobile app is configured to allow subscribers to upload and syndicate content to channels as described above as well as to display customizable feeds and/or industry streaming television stations from the mobile application. The mobile application may include a mobile dashboard allowing subscribers to edit their digital space and/or upload content including articles, videos, photos, and locations. The mobile application may also provide users the ability to, for example, review subscriber content, add bookmarks, share content, and access their personal profile.

### Advertising

In general, the platform described herein can both manage the subscriber's contact information, content, and reviews consistency across multiple local and third party properties, and enable the subscriber to manage a single advertising presence across multiple campaigns and distribution channels. As such, subscribers may manage create, edit, delete, enable, and/or disable on and off platform advertisements using tools provided, for example, in the subscriber's dashboard.

On platform ad placement may be determined by, for example, on platform and off platform meta-tag and keyword page rankings. Ads may be video, mobile, textual, or banner in appearance. In some embodiments, subscribers may choose advertisement landing pages within their own digital spaces and/or select existing web sites or social channels as destinations. In some embodiments, a subscriber's advertisements are distributed to selected registered users and/or other subscribers. Subscribers may be required to pay a fee and in exchange for the distribution of advertisements to selected registered users and/or other subscribers. Off platform ad placement may be determined, for example, by utilizing API connectivity and platform partnerships with other ad networks and search engines. On platform keyword research metrics may be supplied and/or exchanged with off platform ad networks and search engines.

One or more software modules may be configured to control advertising management, optimization, placement, and payment. In some embodiments modules may capture measurements such as, for example, advertising views and/or clicks and use such information to provide feedback to the subscriber. In some embodiments, the module may be configured to receive subscriber budget information and in response provide the subscriber advertising options within the received budget parameters.

In some embodiments systems disclosed herein may be configured to import advertising keywords from a keyword research-tracking and/or predictive database. The system may then select relevant keywords. In some embodiments, subscribers may bid on and/or purchase keywords. The system may receive subscriber location, industry, and/or category data. The system may receive information relating to the subscriber's targeted demographics. The system may receive information relating to the subscriber's budget and time goals. The system may receive information relating to the subscriber's desired distribution channels and amount and type of content the subscriber wishes to distribute. In response to the received information, the system may then create and suggest an advertising campaign tailored to the subscriber's requirements. In some embodiments, the ad management section of the platform can provide the subscriber options and tools to manage, create, launch, measure, and optimize advertising campaigns for inclusion into facebook local ads, Google ad words, mobile advertising, local search engine marketing and other similar channels.

Publishing Centers

In some embodiments the platform comprises a publishing center in which content producers can monetize their published work through their own unique version of a storefront in their digital space. Content producers such as, for example, journalists, writers, analysts, photographers, and videographers may establish their own self-branded content network that can be monetized through the various publishing syndication models that platform offers. Not only can the publishing center empower independent content producers to monetize their self-published work, the publishing center may also enable institutionalized content production companies (newspapers, magazines, publishing houses, books, news companies, etc.) to establish their own publishing centers as a secondary monetization model. Thus, many small and aging publishing companies will be able to monetize work they have published offline through re-syndication to their online publishing center.

In some embodiments, content producers publish their self-branded media to the platform. This published content may be indexed and searched by subscribers and/or by users on the platform or searched with third party search engines. This content may then be viewed on the content producer's own self-branded publishing center on the platform. The content producer's publishing center may also be found by users by searching the platform with a search tool in the user's dashboard. In some embodiments, users and/or subscribers can subscribe to RSS feeds of their favorite content producers on the platform and receive real-time updates of recently published content and media.

In some embodiments, subscribers may bid for storefront banner ad space on the publishing center pages. In some embodiments, one or more software modules are configured to automatically place a subscriber's advertisement on a publishing center's pages based at least in part on the rankings, click through ratio, number of viewers, and/or total traffic that the publishing center receives. One or more software modules may also be configured to place subscriber that are highly relevant to the content that the publishing center publishes because the subscriber and the publishing centers are on the same platform and thus, the software module has accesses to large amounts of data supplied by both the subscriber and the publishing center as well as other internal analytical data captured by the platform. Thus, the platform may provide a means for linking end users, content producers, and subscribers that sell relevant products and services to viewers of that content. Such software modules may also have unique access to, for example, I.P. addresses of users, subscribers, and content producers, access to time and day information, weather information, previous platform interactions, interests, incentives, discounts, purchasing habits, and any other platform interaction that can be used to refine relevant storefront banner ad insertion. Thus, the modules may produce a cost effective way of driving relevant traffic to the subscriber storefronts.

For example, a content producer may write and upload an article to the platform. A registered user may search key words on the platform or with a third party search engine and the article may be displayed to the user. The platform may have previously received information relating to the registered user's place of residence or the I.P. address may be used to determine the registered user's location. The platform may then use this key word information, location information, and/or other information specific to the content producer, published content and/or registered user to display a subscriber's banner ads on the content producer's page when the registered user views the page. Thus, the subscriber and registered user can benefit from the placement of a highly specific banner ad.

In some embodiments, the banner ad comprises a subscriber's product catalog API that may also be inserted with the subscriber's information. Thus, an end user may engage in a product purchase directly from the media page on the publishing center. Such banner ads may also comprises a calendar, video, or contact form API displaying to the end user the subscriber's availability, product and/or service demonstration, and/or allow the end user to contact the subscriber directly. In some embodiments, subscribers may choose what type of banner ad API's they want to place throughout the platform and bid on that ad space based at least in part on the traffic/demand that the media garnishes. In some embodiments, the platform may receive a portion or percentage of the banner ad placement fee when a subscriber bids on ad space.

Subscribers on the platform may also engage content producers to produce luminary content on their behalf. Based on, for example, the engagement permissions the content producer grants the subscriber, the subscriber may then syndicate the content producer's content on the subscribers selected distribution channels. In some embodiments, the content producer's content is automatically converted to an RSS that is displayed on their own publishing center's digital space or other off platform site. Thus, traffic may be driven from the content producer's digital space to the subscriber's and vice versa.

In some embodiments, price points may be based at least in part on the quality of the media produced, the volume of media produced, the duration of the engagement, the following the content producer has acquired, and the industry the content producer is writing for. Subscribers may hire content producers for various types of engagements ranging from a one-time article to a full time production engagement can be established through the platform. In some embodiments, the platform will require a transaction fee for each time a subscriber engages a content producer through the platform which may be based at least in part on the price points.

In some embodiments, end users of the platform may be allowed to RSS in free media from the content producers publishing centers. In other embodiments, end users of the platform may only access certain portions of the publishing centers media for free and can only be access the remainder of the content through a paid subscriptions received by the platform. In some embodiments, the platform will take a percentage of the subscription fee each time an end user subscribes to paid subscription portion of the content producers publishing center. In some embodiments, the platform includes a tool that enables a content producer to submit their published media for copyright protection.

In order to ensure the quality of the writer on the platform, in some embodiments, prospective writers may be required to pay an initial qualification fee to have their publishing center activated or expanded. The qualification process may entail tutorials on how to effectively use the platform and/or position how to published content within the platform. Such tutorials may be stored as a dynamic tool on a backend dashboard that may be accessed after they are qualified.

Publishing centers may select what industries they desire to produce content for in some embodiments, the publishing centers must qualify each industry they desire to write for prior to having the ability to distribute such content. In some embodiments, the platform may include pre-selected topics for each industry that may be displayed to publishing centers. The publishing centers may then select the topic to produce content about. In some embodiments, subscribers in industry categories may be polled such that topics may be identified. In some embodiments, content produced by a publishing center may be first reviewed by an editor before it is approved for distribution on the platform.

In some embodiments, subscribers may be able to place insight banner ads with a link to one or more pages of the subscriber's digital space on the content producers pages. The subscriber may pay a nominal one-time fee to purchase the insight banner advertisement space from the content producer. Although the content may live and index on the content producer's page, the article may also RSS into the media channel of the subscriber that left their professional insight. In some embodiments, if an article is viewed within the subscriber's digital space, the subscriber's insight will be highlighted and displayed first in the professional insight or comments section. In some embodiments, the subscriber may only be able to comment on media that is relevant to the industry they are providing insight on. In some embodiments, only a limited number of professional insight banner ad spots (e.g., 5-10) will be available. In some embodiments, one or more software modules are configured to provide an automated qualification system that enables only relevant subscribers to qualify as a syndicator of a particular piece of published media. Thus, subscribers may be able to advertise their business based on the unique insights they have about a particular piece of media, and not just a static banner ad. Insight Banners may personalize the businesses and build trust with consumers on a non-invasive level and/or provide permanent banner ad exposure at a cost-effective price, populate the media channel of the subscriber, and drive residual consumer traffic to the subscriber's digital space or other webpages from the insight banner ads storefront link.

In some embodiments, content producers may be able to write non-indexed content that they may sell in the form of products to subscribers. Content producers may write individual articles or sets of articles that can then be sold as a product to the subscriber. To protect such work, pre-written work copyrights may be obtained through the platform. Thus, in some embodiments, the subscriber may only buy the content while the content producer retains the copyright. In some embodiments, when a subscriber purchases content, the content is indexed in the subscriber's digital space and/or media channel. The indexed content may also RSS into the content producers publishing center and go out to all the end-users that subscribe to the content producers content. The subscriber's storefront information may be placed within the purchased content to give more exposure for the subscriber when the content is being viewed through the content producer's network. This may empower content producers with a large subscriber base to charge higher prices to produce content for the subscriber because of the additional exposure that their publishing center and subscriber base will generate for the subscriber.

### Call Tracking

In some embodiments, the platform may be linked to a subscriber's landlines and/or VoIP networks. Thus, the platform may be configured to track calls to and from the subscriber and capture such data. Call waiting, custom voicemail, phone based lead capture and other features may be integrated into the platform. The platform may display analytics on the calls to subscribers. Such analytics may includes, for example, the total number of calls, location base calls, time of the year, and number of calls graph for each industry.

### Examples

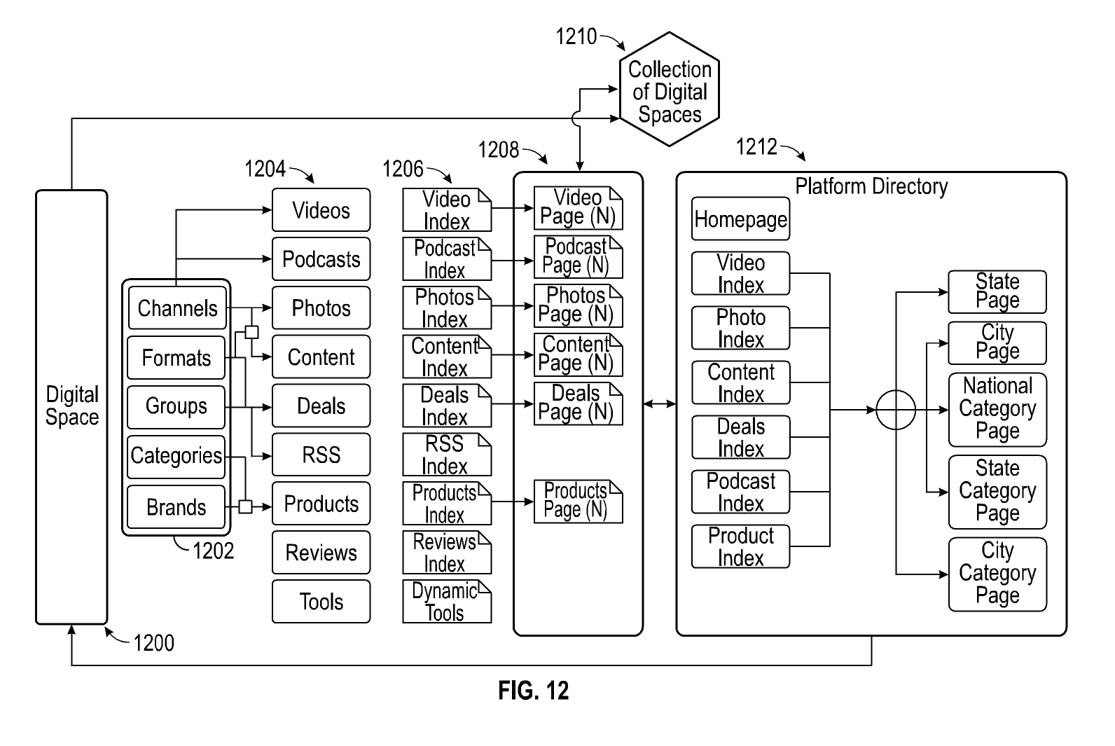

FIG. 12 shows an example block diagram architecture for digital spaces on the platform and indexing thereof. As discussed above, the platform may include a collection of digital spaces 1210 and each digital space 1200 may include one or more pages 1208. Subscribers and/or registered users may have access to a dashboard 1202 that can manage their digital space 1200. The dashboard 1202 may include a channel selection interface configured to allow a user to select distribution channels for their uploaded media. Such media may include videos, podcasts, photos, and/or written content. The dashboard 1202 may also include a formatting interface configured to allow user to change the format of media deals and/or RSS feeds as well as edit the format of uploaded media. The dashboard may also include a group selection interface. The group selection interface may allow the subscriber to select groups of registered users, subscribers, customer lists, and/or e-mail groups that they wish to distribute specified deals, media, and/or RRS feeds to. The dashboard may also include a category selection interface. In some embodiments, the category selection interface is configured to allow a subscriber to for example select categories of products the subscriber wishes to display on their digital space and/or distribute through media channels. The dashboard may also include a brand selection interface. The brand selection interface may be configured to allow a subscriber to select certain brands of products and/or services the subscriber wishes to publish information about on their digital space.

In general, each type of content that is published in the digital space and/or distributed through distribution channels is indexed on the platform by content type. Such an index can allow users to browse and/or filter content using layers and/or hierarchical categories. The platform directory 1212 may store and/or access the indexing information. The platform directory 1212 may then be searched using keywords and/or filtering the data using content specific indexes. In some embodiments, the platform directory indexes information by geographic location. Information may also be indexed according to industry type and/or subtype and/or subtlety specialty. Geographic ration and industry information may be provided by subscribers and/or obtained through metadata.

Having information indexed in such a way allows a user of the platform to quickly find relevant search results. For example, a user may wish to find a photo of a guitar for sale in his neighborhood. Using, for example, a plurality of drop-down menus that interact with one or more software modules that may filter information that is indexed in the platform directory, a user may choose to view only results from photo content, on an ecommerce page, in the industry category of guitar sellers, and located with or near a specific selected neighborhood which will yield accurate and fast search results for the user, even without the use of keyword search terms.

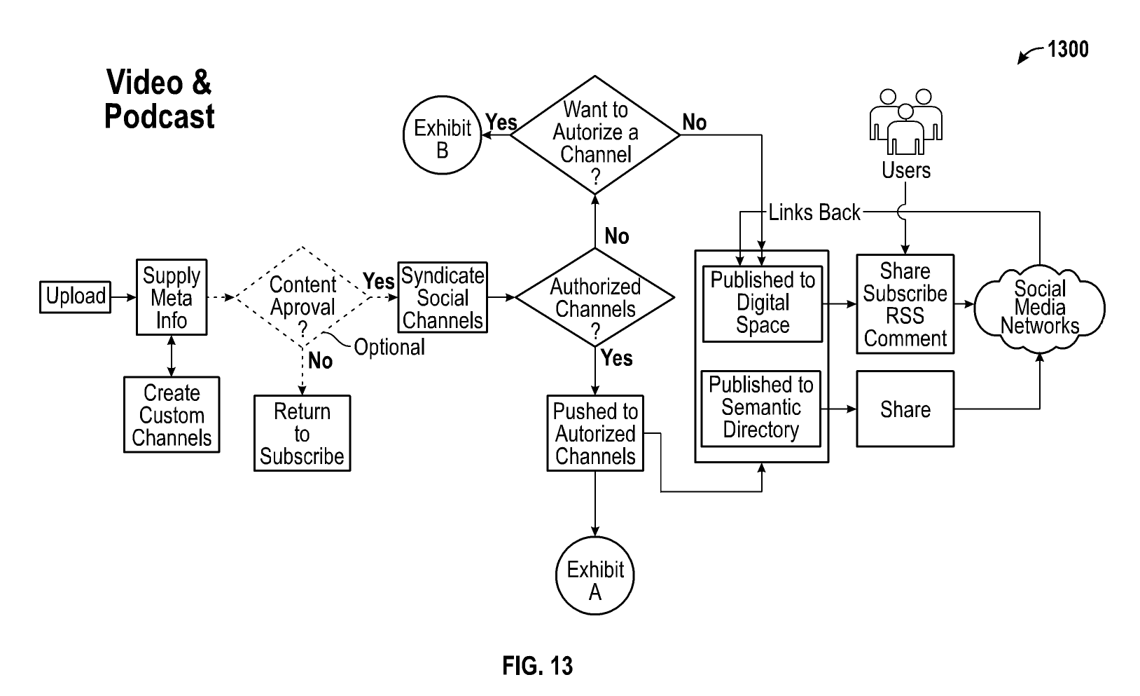

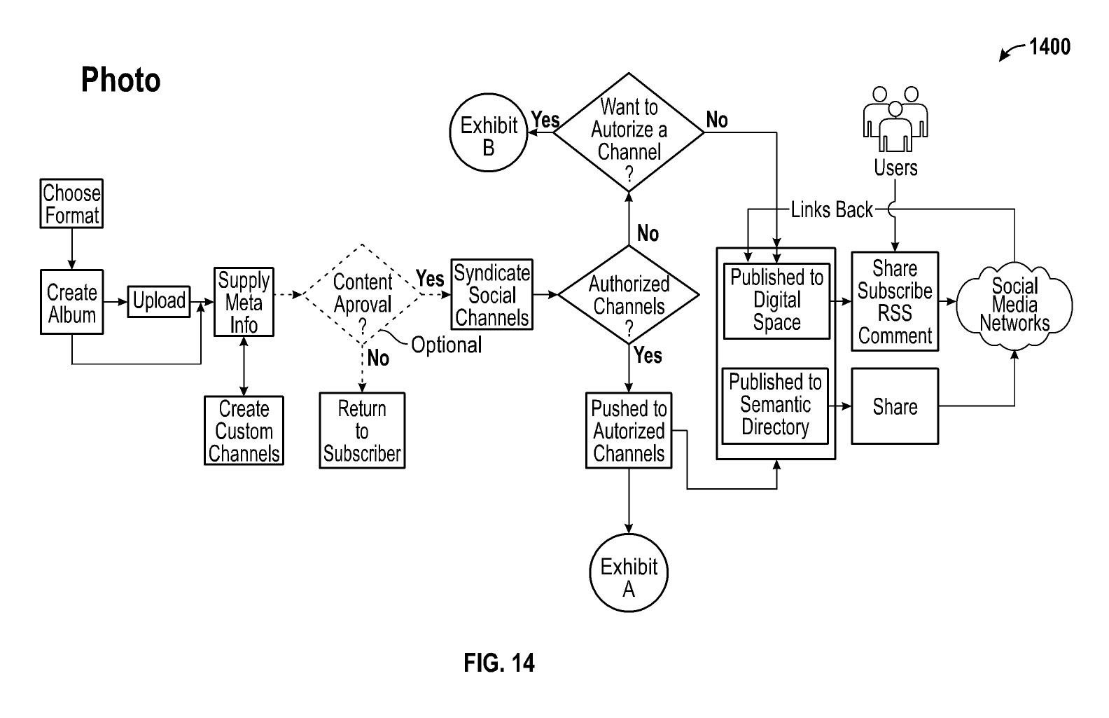

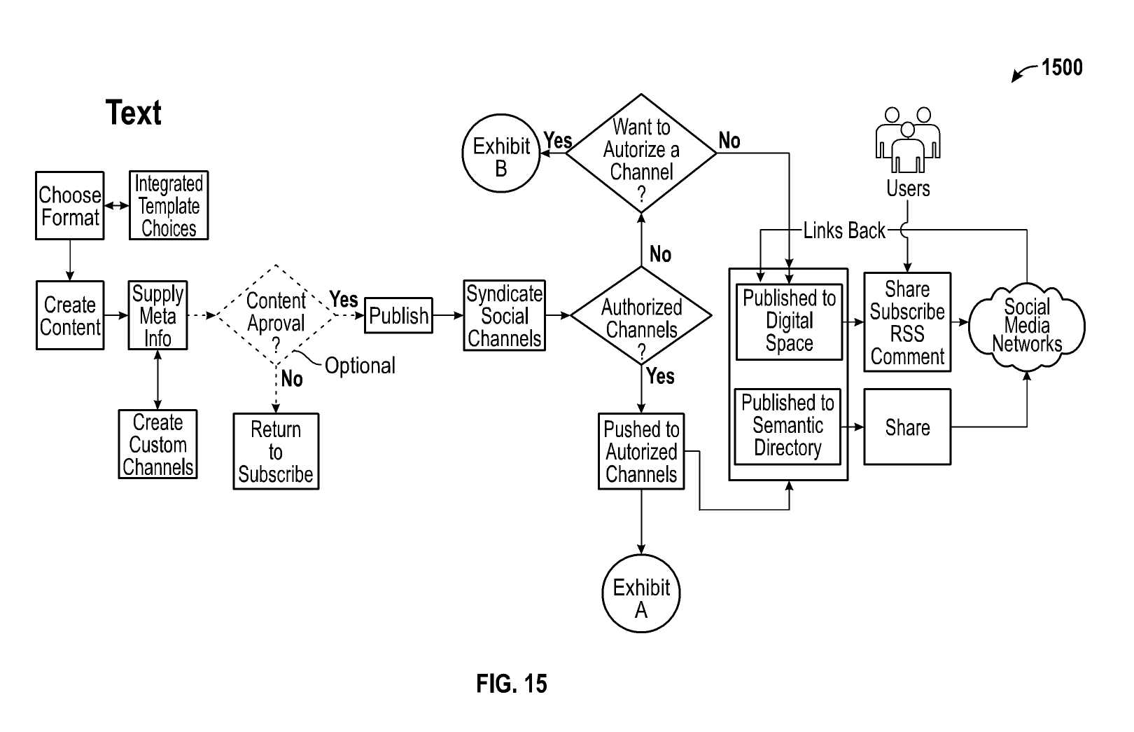

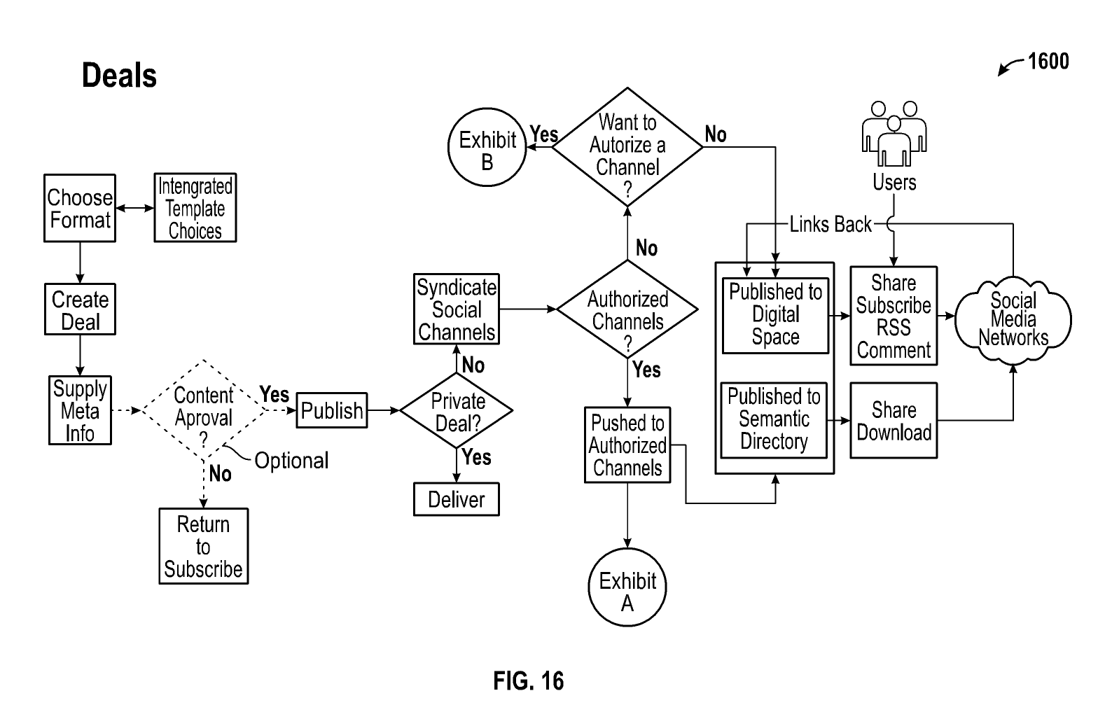

Turning to FIG. 13, a block diagram for a system and method for distributing video and/or audio according to one embodiment 1300 is illustrated. As shown in FIG. 13 and described in greater detail above content may be uploaded and meta-information may be supplied to the content. Custom content channels may be created. In some embodiments the content is subject to pre-approval before it is published and/or distributed. The content may then be syndicated through distribution channels such as social media channels. If the channel is authorized, the content may be pushed to the authorized channel. The content may be indexed and published to a semantic directory and/or published in the subscriber's digital space. Content that is published in the digital space and/or semantic directory may be shared with social media networks. Such shared content may include a link back to the subscriber's digital space. Users may encounter shared content on social media networks and interact with the content by also sharing the content, commenting on the content, and/or subscribing to additional content published by the subscriber. Throughout this process, the subscriber's content may always include a link directing a user back to subscriber's digital space. FIG. 14 illustrates an example block diagram block diagram for a similar system and method for distributing photos 1400 and FIG. 15 illustrates an example block diagram for a similar system and method for distributing textual content 1500. FIG. 16 illustrates an example block diagram for similar system and method for creating and distributing deals 1600. Private deals may be distributed to registered users, customer lists, and/or targeted e-mails.

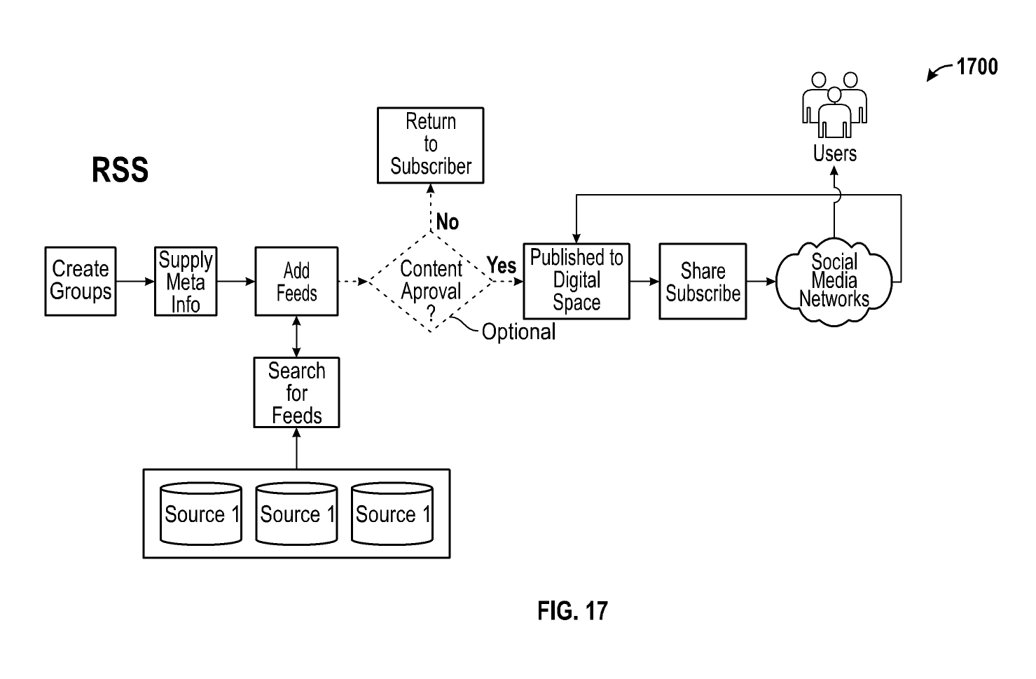

Turning to FIG. 17 an example block diagram for a system and method for retrieving, publishing, and distributing, content from RSS feeds is illustrated 1700. Content groups may be created and supplied with meta-information. RSS feeds may be searched for and added to a content group. For example, a subscriber may wish to create a content group for local cyclists in his area. Thus, the subscriber may provide information to the platform which in return supplies meta-information for his content group. The subscriber may then search for RSS feeds that are relevant to local cyclists and add such feeds to the content group. In some embodiments, the subscriber may create their own RSS feed which may be automatically fed to one or more RSS search engines. In this way a plurality of related RSS feeds may be published on a unique page within the subscriber's digital space. These pages may then be shared through social media networks and/or subscribed to by users.

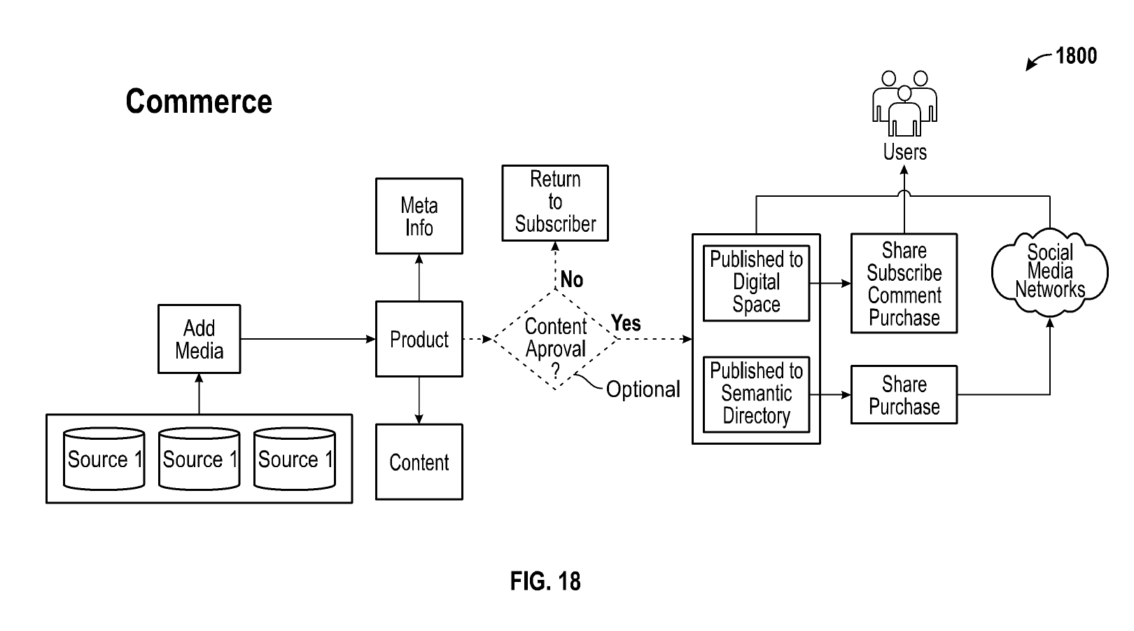

FIG. 18 illustrates an example block diagram for system and method for e-commerce on the platform 1800. Media relating to a product may be added to a product page. Meta-information may be embedded automatically to a product page. The product page may then be published on the digital space and shared.

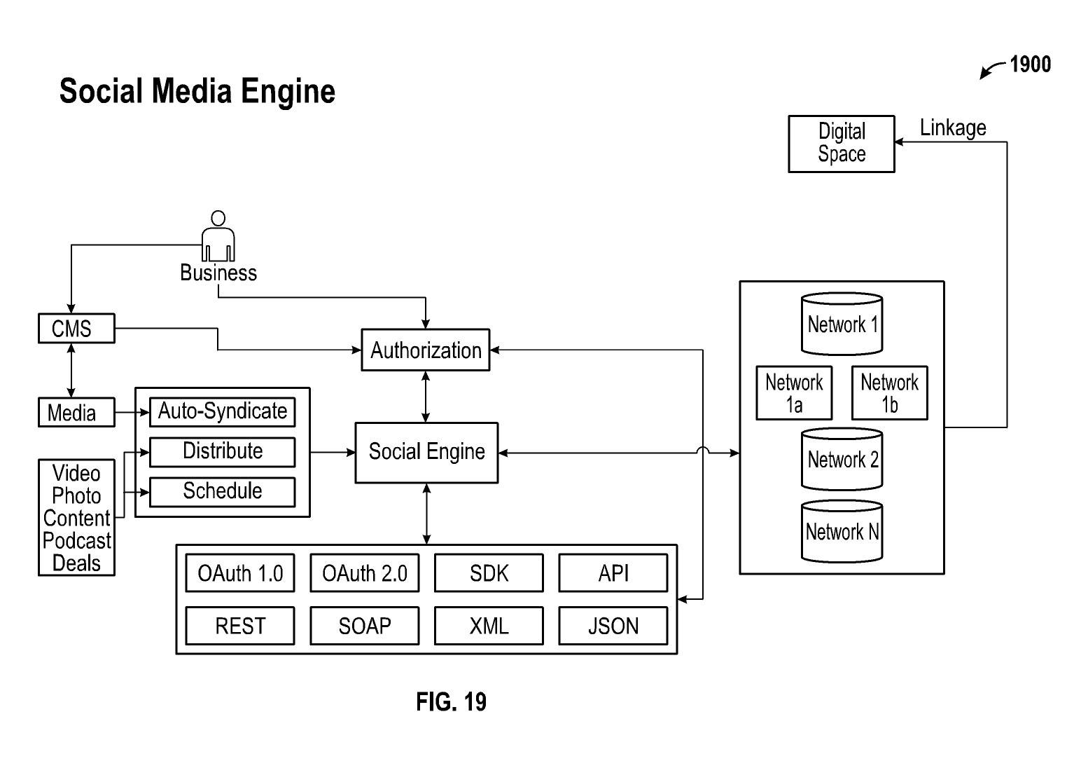

FIG. 19 shows an example block diagram of a social media engine according to one embodiment 1900. Disclosed herein are method and process for managing multiple social media networks and multiple accounts within those networks from a centralized multimedia CMS publishing system. Features such as automated syndication, triggered redistribution, sharing, communication, commentary, and synchronized presentation into unique web pages hosted within a directory are provided to subscribers.

As shown, for example, in FIG. 19, subscribers may supply log in credentials for any social network, for any number of accounts within that network, manage the insertion of media into the accounts, and monitor the communication cycle, surrounding commentary, and updating of status options from one platform. In some embodiments, subscribers may schedule distributions of content within a plurality of media formats to their selected accounts. The subscriber's dashboard may allow subscribers to post public media, edit status updates, reply to messaging components and/or deliver marketing incentives, offerings and deals, publically or privately, to connected contacts within each network. As shown, the social media engine may also incorporate and utilize multiple web based protocols such as, for example, OAuth 1.0 & 2.0, SDK's, API's, REST, SOAP, XML & JSON standards.

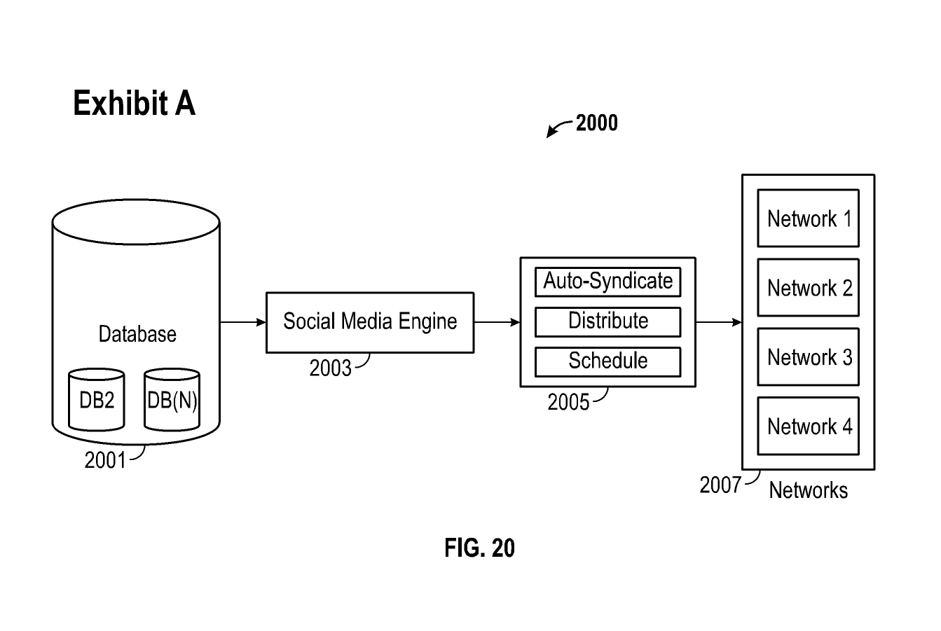

FIG. 20 shows an example block diagram for a system and method for publishing content 2000 that is uploaded to the platform. A social media engine 2001 may extract the content from the platform database. The social media engine 2001 include an interface 2005 configured to allow subscribers to auto-syndicate, distribute, and schedule publications in part in response to input from subscribers. The content may then be distributed to one or more networks 2007.

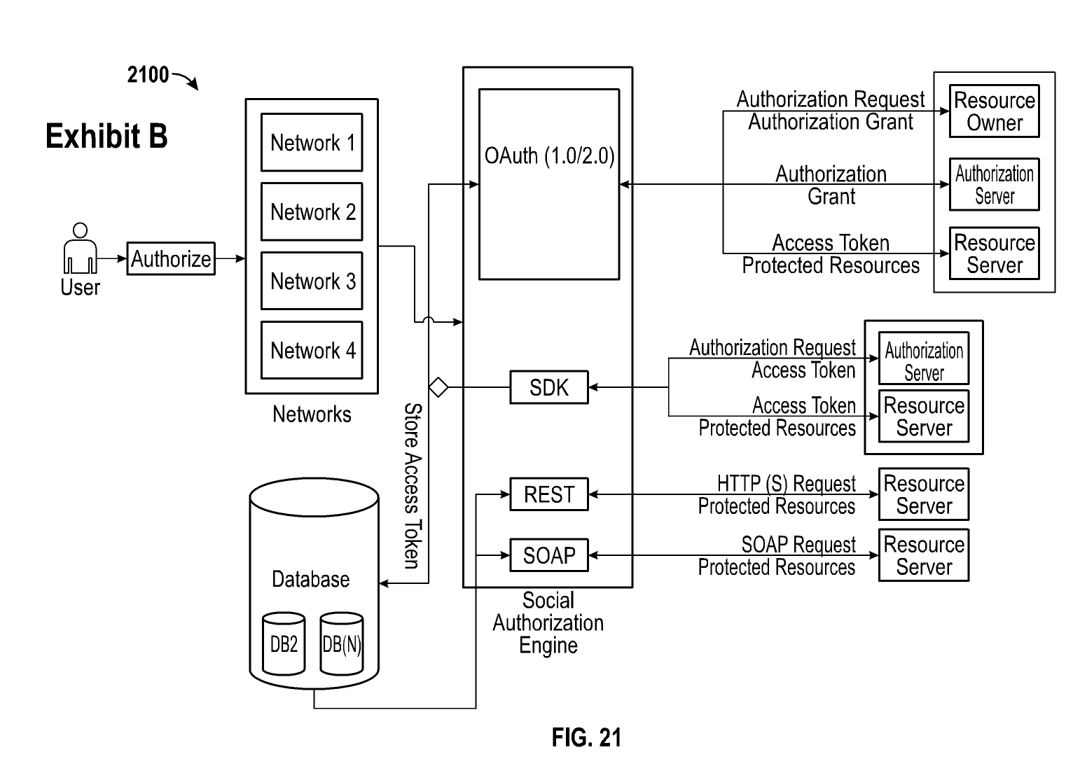

FIG. 21 shows an example block diagram for a system and method for authorizing distribution channels 2100. A user may authorize a plurality of networks to supply information to a social media engine. Resources from a plurality of resource servers may be obtained from one engine that utilizes multiple protocols.

### Badges and Search Rankings

In some embodiments, the platform includes an internal search engine that is configured to adjust search result rankings based at least in part on the subscriber's ranking on the platform. In some embodiments a subscriber may improve their ranking(s) by increasing their interactions with the platform. A subscriber's ranking on the platform may be increased by, for example, earning qualification points on the platform, increasing the subscriber's interactions with users, and/or publishing more content.

Qualification points can be earned when a subscriber achieves certain milestones or accomplishments. Since the qualification points contribute to subscriber's search result ranking, the subscriber will be encouraged to earn such points. In some embodiments, when a certain level and/or type of qualification points are earned by the subscriber, the subscriber may obtain a badge. These badges may be displayed on content available to visitors of the subscriber's digital space. Thus, the badges can be used to display the subscriber's accomplishments to users and other subscribers. Display of the badges may help the subscriber gain confidence from users and other subscribers.

In some embodiments a subscriber's search ranking result may be increased when the subscriber reaches certain content production milestones. For example, subscribers may earn points each time they upload content to the platform. This accumulation of points in turn increases the subscriber's search result ranking. Points may be earned by publishing different types of media and more points can be earned by uploading more of that content. In some embodiments, points are earned and the deposited in virtual bins for each type of media that is published. For example video points may be earned by uploading videos, photo points may be earned by uploading photos, review points may be earned by receiving reviews. In some embodiments, the point level achievement system is tiered. Badges may be earned in a similar manner.

For example, a subscriber may obtain a tier 1 photo badge by uploading 10 unique photos. The subscriber may later obtain a tier 2 photo badge by uploading 100 unique photos. Similarly, the subscriber may obtain a tier 1 video badge by uploading 10 unique videos. The badges may be color-coded based on tier. For example, all tier 1 badges may be white and all tier 2 badges may be orange. In some embodiments, photos must be of a certain size in order to qualify for points. Similarly, the platform may require, for example, videos to be of certain length or content to contain a certain lines of text in order to receive points thus further ensuring that quality content is uploaded by subscribers.

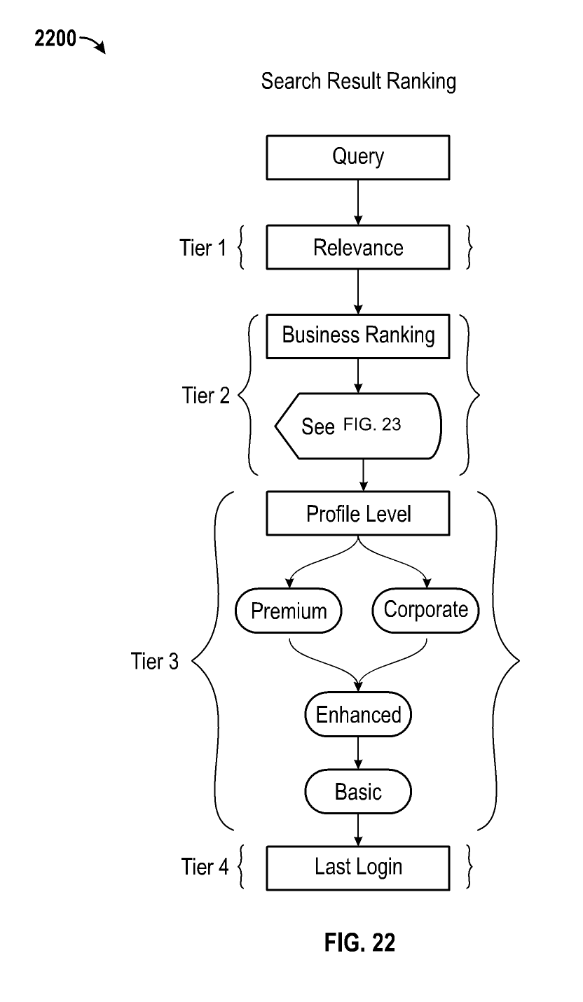

In some embodiments the internal search engine is configured to rank search results based at least in part on subscriber keywords, subscriber rankings, subscriber subscription level, and/or subscriber log-in information. As shown in FIG. 22 for example, internal search engine may be configured to sort information using a tiered system 2200. First, information provided by a user such as, for example, keywords, industry categories, and location information will be used by the search engine to locate relevant results (Tier 1). Subscribers may be able to purchase key words in order to improve results. Search results with similar relevance may then be sorted and displayed to users based on the subscriber's point rankings (Tier 2). Thus, the more active subscribers will be displayed to users more prominently than less active subscribers. Search results with similar subscriber point rankings may then be sorted and displayed to users based on the subscriber's subscription plan (Tier 3). Platform subscription plans may include premium plans, corporate plans, enhanced plans, and basic plans. Thus, subscribers with more expensive plans may be displayed to users more prominently than subscribers with less expensive plans. Lastly, search results with similar subscription plans may be sorted by the last log-in date/time. Thus, subscribers who have used the site more recently will be displayed more prominently.

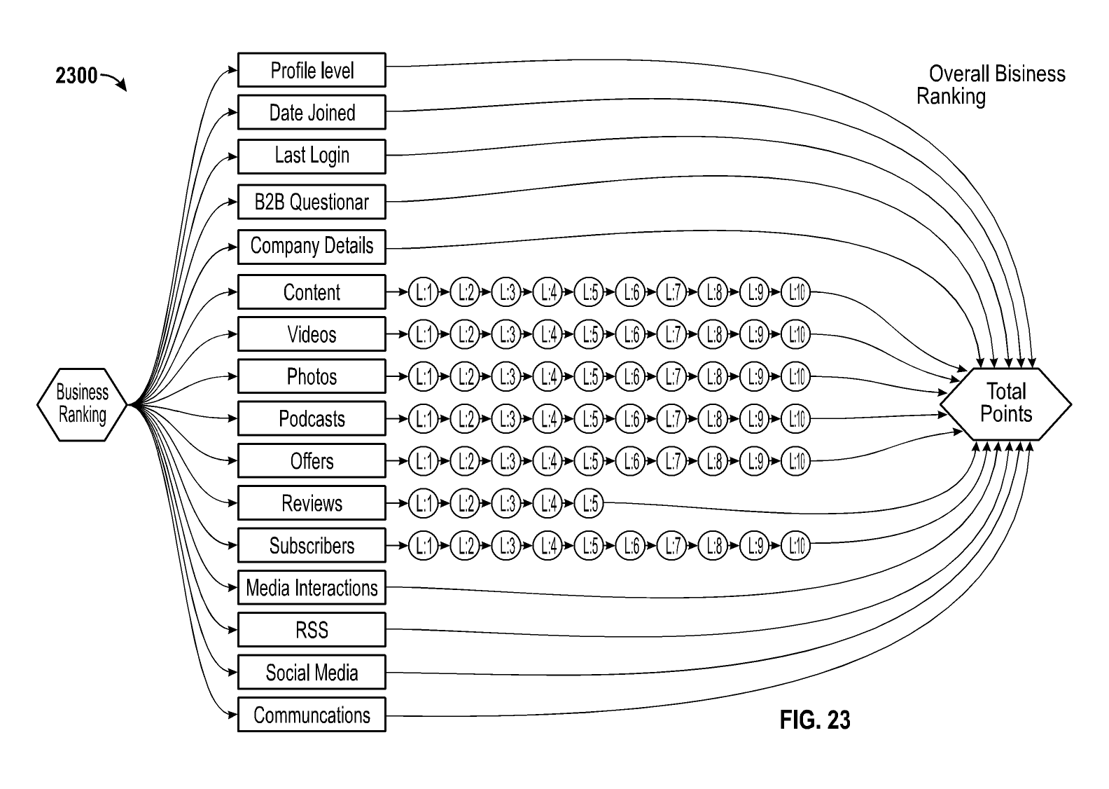

Turning to FIG. 23, a block diagram illustrating an embodiment of a business ranking system 2300 on the platform is shown. Points may be earned by subscribers for profile level, time of use, number of log-ins, supply of information to the platform about the subscriber's business, completion of questioners, number of uploads, content size, number of reviews, number of subscribers, number of media interaction, number of RSS feeds, number of social media channels, and number of communications to subscribers and/or users. Various levels may be obtained. In some embodiments, levels for certain types of points may be capped.

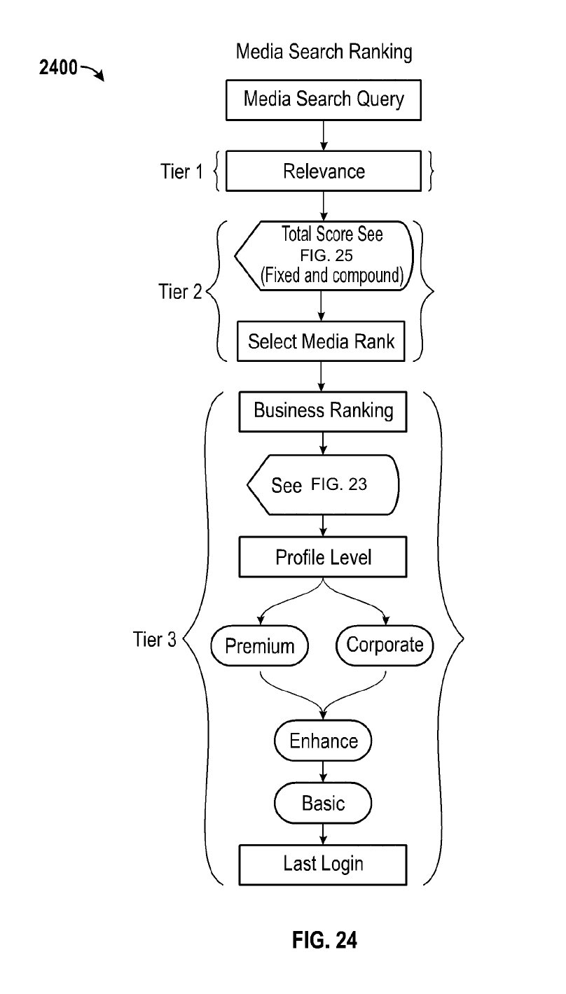

In some embodiments, the internal search engine may be configured to search for specific types of media. A drop down menu may allow for a searcher to limit search results to, for example, only photos, or only textual content. An example of such a system and method 2400 is shown in the block diagram of FIG. 24. Tiered search engine results may be similar to those as the internal search engine described above. However, the search results with similar relevance may then be sorted and displayed to users based on the subscriber's specific point ranking for the specified media that the user is searching for. For example, relevant photos from a subscriber with a level 10 photo badge may be displayed more prominently than relevant photos from a subscriber with a level 5 photo badge.

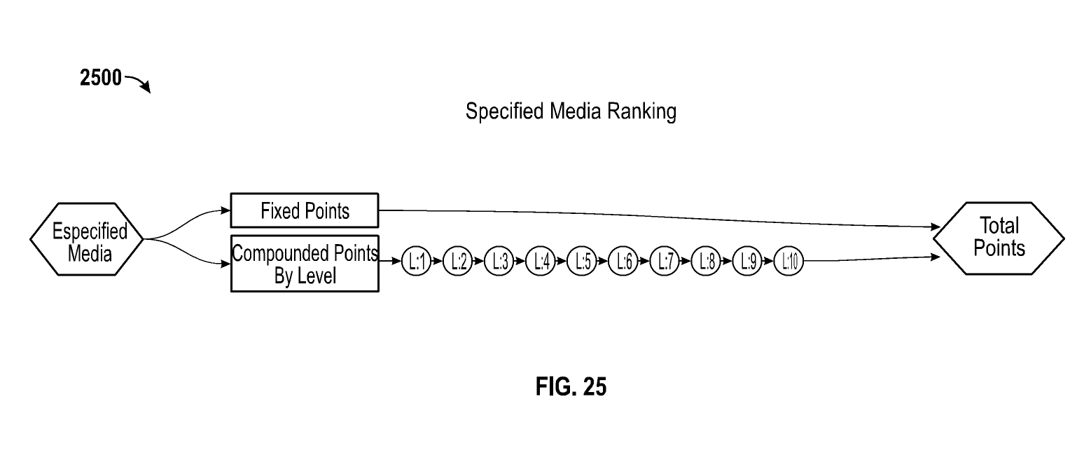

FIG. 25 shows an example of a point system for specific media 2500. In some embodiments certain fixed point amounts may be awarded to a subscriber for initially uploaded a specified media type. Additional points may be earned and compounded until certain point levels are achieved. The more points that a subscriber has for a specified type of media, the more prominently the subscribers results will be displayed to users who are searching for the specified content.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without user input or prompting, whether these features, elements or steps are included or are to be performed in any particular embodiment. Moreover, unless specifically stated otherwise, or otherwise understood within the context as used, is generally intended to convey utilization of the conjunction “or” in enumerating a list of elements does not limit the selection of only a single element and can include the combination of two or more elements.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description and appendices may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that any of the various illustrative logical blocks, modules, cores, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, cores, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, cores, and circuits may include antennas and/or transceivers to communicate with various components within the network or within the device. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules or cores may be implemented in some other manner as taught herein. Furthermore, the functionality described herein (e.g., with regard to one or more of the accompanying figures) may correspond in some aspects to similarly designated “means for” functionality in the appended claims.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The functions described may be implemented in hardware, software, firmware, or any combination thereof. If implemented in software, the functions may be stored on or transmitted over as one or more instructions or code on a tangible, non-transitory computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium may be in the form of a non-transitory or transitory computer-readable medium. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In summary, it should be appreciated that a computer-readable medium may be implemented in any suitable computer-program product.

While various aspects and embodiments have been disclosed herein, other aspects and embodiments will be apparent to those skilled in the art. The various aspects and embodiments disclosed herein are for purposes of illustration and are not intended to be limiting. Reference is also made to Appendices A-D filed herewith which contain additional information about the systems and methods that can be implemented in various embodiments of the present invention.

What is claimed is:

1. A computer implemented internet publishing platform comprising:
one or more computer implemented servers with associated non-transient computer readable memory comprising:
data storage space resident on non-transitory computer readable media configured to define a plurality of digital spaces available to a corresponding plurality of platform subscribers;
wherein the servers comprise processing circuitry configured for operation with one or more software modules stored on non-transitory computer readable media, wherein the software modules comprise instructions that cause the processing circuitry to:
present user interfaces to a plurality of platform subscribers that allow access by platform subscribers to their corresponding digital spaces for uploading information and content to their corresponding digital spaces, displaying selected uploaded content to visitors of the digital spaces, publishing uploaded content to selected destinations on the internet; and receiving information and content from the digital spaces;
present at least one user interface to at least one master subscriber different from the platform administrator, wherein the user interface allows at least some control by a master subscriber over a defined subset of the digital spaces of the platform subscribers, the control allowing at least one of preventing the display of selected uploaded content to visitors of the digital spaces and preventing the publication of uploaded content to selected destinations on the internet.

2. The computer implemented internet publishing platform of claim 1, wherein the at least some control comprises selectively enabling and disabling options provided on user interfaces presented to subscribers associated with the defined subset of digital spaces.

3. The computer implemented internet publishing platform of claim 1, wherein the at least some control comprises viewing uploaded content on each of the subset of digital spaces for approval.

4. The computer implemented internet publishing platform of claim 1, 2, or 3, wherein each subscriber associated with a digital space of the defined subset of digital spaces is contractually affiliated with the master subscriber.

5. A computer implemented internet publishing platform comprising:
one or more computer implemented servers with associated non-transient computer readable memory comprising:
data storage space resident on non-transitory computer readable media configured to define a plurality of digital spaces available to a corresponding plurality of platform subscribers;
wherein the servers comprise processing circuitry configured for operation with one or more software modules stored on non-transitory computer readable media, wherein the software modules comprise instructions that cause the processing circuitry to:
present user interfaces to a plurality of platform subscribers that allow access by platform subscribers to their corresponding digital spaces for uploading information and content to their corresponding digital spaces, displaying selected uploaded content to visitors of the digital spaces, publishing uploaded content to selected destinations on the internet; and receiving information and content from the digital spaces;
determine, for at least some platform subscribers, an amount of at least one of uploaded content items, uploaded video items, uploaded photos, uploaded podcasts, media interactions, consumer reviews received, and consumer offers made; and
provide a reward to at least some platform subscribers based at least in part on the determined amount.

6. The computer implemented publishing platform of claim 5, wherein the reward comprises ranking results of platform visitor search queries for display to the platform visitor based at least in part on the determined amount.

7. A computer implemented internet publishing platform comprising:
one or more computer implemented servers with associated non-transient computer readable memory comprising:
data storage space resident on non-transitory computer readable media configured to define a plurality of digital spaces available to a corresponding plurality of platform subscribers;
wherein the servers comprise processing circuitry configured for operation with one or more software modules stored on non-transitory computer readable media, wherein the software modules comprise instructions that cause the processing circuitry to:
present user interfaces to a plurality of platform subscribers that allow access by platform subscribers to their corresponding digital spaces for uploading information and content to their corresponding digital spaces, displaying selected uploaded content to visitors of the digital spaces, publishing uploaded content to selected destinations on the internet; and receiving information and content from the digital spaces;
wherein the user interfaces are configured to allow subscribers to push uploaded content to different websites having URLs associated with the subscribers and that are hosted on computer implemented servers different from the computer implemented servers hosting the digital spaces so as to populate and generate HTML pages of subscriber websites with content published through their respective digital spaces.

8. The computer implemented publishing platform of claim 7, wherein the user interfaces are configured to allow selective website link sharing between different websites of different subscribers.

9. A computer implemented internet publishing platform comprising:
one or more computer implemented servers with associated non-transient computer readable memory comprising:
data storage space resident on non-transitory computer readable media configured to define a plurality of digital spaces available to a corresponding plurality of platform subscribers;
wherein the servers comprise processing circuitry configured for operation with one or more software modules stored on non-transitory computer readable media, wherein the software modules comprise instructions that cause the processing circuitry to:
present user interfaces to a plurality of platform subscribers that allow access by platform subscribers to their corresponding digital spaces for uploading information and content to their corresponding digital spaces, displaying selected uploaded content to visitors of the digital spaces, publishing uploaded content to selected destinations on the internet; and receiving information and content from the digital spaces;
automatically distribute content uploaded by the subscriber to network destinations pre-selected by the subscriber using the user interfaces prior to uploading.

10. A computer implemented internet publishing platform comprising:
one or more computer implemented servers with associated non-transient computer readable memory comprising:
data storage space resident on non-transitory computer readable media configured to define a plurality of digital spaces available to a corresponding plurality of platform subscribers;
wherein the servers comprise processing circuitry configured for operation with one or more software modules stored on non-transitory computer readable media, wherein the software modules comprise instructions that cause the processing circuitry to:
present user interfaces to a plurality of platform subscribers that allow access by platform subscribers to their corresponding digital spaces for uploading information and content to their corresponding digital spaces, displaying selected uploaded content to visitors of the digital spaces, publishing uploaded content to selected destinations on the internet; and receiving information and content from the digital spaces;
automatically modify at least some uploaded content to include semantic markup according to one or more industry standard micro formats.

11. The computer implemented publishing platform of claim 10, wherein the associated non-transient computer readable memory stores format information for a plurality of micro formats for use when uploaded content is automatically modified.

12. The computer implemented publishing platform of claim 11, wherein the instructions cause the processing circuitry to integrate at least some items of the uploaded content into separate web pages available to search engines connected to the internet.

13. The computer implemented publishing platform of claim 12, wherein the instructions cause the processing circuitry to integrate each item of the content into a separate web page available to search engines connected to the internet.

14. A method of publishing user created content to a wide-area-network comprising:
receiving a plurality of content items from a user in a corresponding plurality of content formats;
integrating each item of the content into a separate web page available to search engines connected to the wide area network.

15. The method of claim 14, additionally comprising sending each item of content to a user selected destination on the wide-area network.

16. A computer implemented internet publishing platform comprising:
one or more computer implemented servers with associated non-transient computer readable memory comprising:
data storage space resident on non-transitory computer readable media configured to define a plurality of digital spaces available to a corresponding plurality of platform subscribers;
wherein the servers comprise processing circuitry configured for operation with one or more software modules stored on non-transitory computer readable media, wherein the software modules comprise instructions that cause the processing circuitry to:
present user interfaces to platform subscriber computers coupled to the internet that allow access to the digital spaces for uploading information and content to the digital spaces and for receiving information and content from the digital spaces;
receive and store content in a plurality of media formats received from the plurality of platform subscribers;
integrate items of content received from the plurality of platform subscribers into separate web pages available to at least some search engines coupled to the internet;
search at least portions of the internet for information related to at least one of the plurality of subscribers, to store the information in one or more of the digital spaces, and to present the information to at least one subscriber; and
send items of content received from the plurality of subscribers to social media sites coupled to the internet.

17. A computer implemented method of managing an internet presence comprising:
accessing a data storage space over the internet;
uploading content to the data storage space;
selecting a plurality of additional destination sites on the internet for the uploaded content;
retrieving information from the data storage space collected from the internet that relates to third party access to, use of, or commentary on the uploaded content.

18. The computer implemented internet publishing platform of claim 16, wherein the one or more servers are further configured to provide an integrated programming environment to execute one or more unique application programs.

19. The computer implemented internet publishing platform of claim 16, wherein a user interface of a unique application program is displayed within one or more of the user interfaces presented by the one or more software modules.

20. The computer implemented internet publishing platform of claim 1618, wherein the integrated programming environment comprises an application programming interface.

21. The computer implemented internet publishing platform of claim 20, wherein the application programming interface enables a plurality of software components to communicate with each other.

22. The computer implemented internet publishing platform of claim 20, wherein the application programming interface enables a plurality of software components to communicate with the one or more software modules.

23. The computer implemented internet publishing platform of claim 20, wherein the application programming interface enables at least one of the one or more unique application programs to communicate with a network.

24. The computer implemented internet publishing platform of claim 16, further comprising a software module configured to transmit a network message to a mobile device, the network message configured to be received and processed by an Internet publishing platform specific application program executing on the mobile device.

25. The computer implemented publishing platform of claim 16, further comprising one or more software modules configured to create and publish a plurality of media or content types to unique web pages hosted by the Internet publishing platform.

26. The computer implemented publishing platform of claim 25, further comprising one or more software modules configured to add one or more data tags to the unique web pages to increase the ranking of the unique web pages by an Internet search engine.

27. The computer implemented publishing platform of claim 16, further comprising one or more software modules configured to publish a really simple syndication (RSS) feed in response to the addition of media or content into the digital space.

28. The computer implemented publishing platform of claim 27, further comprising one or more software modules configured to submit the really simple syndication feed to one or more RSS search engines in response to the addition.

29. The computer implemented publishing platform of claim 16, further comprising one or more software modules configured to retrieve content from a really simple syndication (RSS) feed, and store the retrieved content in the digital space.

30. The computer implemented publishing platform of claim 16, further comprising one or more software modules configured to make available for download a browser plugin configured to integrate with the publishing platform.

31. The computer implemented publishing platform of claim 30, wherein the browser plugin is further configured to collect metrics on traffic patterns or websites visited.

32. The computer implemented publishing platform of claim 30, wherein the browser plugin is further configured to display information indicating a digital conversation corresponding to the digital space on a user interface.

33. The computer implemented publishing platform of claim 16, further comprising one or more software modules configured to establish a relationship between selected subscribers, wherein sharing of information, media, content, files, contacts, conversations or connections between the selected subscribers is based, at least in part, on the relationship.

34. The computer implemented publishing platform of claim 16, further comprising one or more software modules configured to periodically assigning value points to a plurality of media types within the digital space based on a locality or vertical category of the digital space.

35. The computer implemented publishing platform of claim 34, further comprising one or more software modules configured to transmit a network message configured to cause a receiver to display at least two different media types in a single list view.

36. The computer implemented publishing platform of claim 16, further comprising one or more software modules configured to receive business information from a user, and to configure one or more directories, services, local map searches, mobile applications or search engines in response to receiving the business information.

37. The computer implemented publishing platform of claim 36, wherein business information is contact information of a subscriber.

38. The computer implemented publishing platform of claim 16, further comprising:
one or more software modules configured to:
receive information relating to a subscriber's business type, industry, category or geography;
determine a list of keywords based on the received information; and
insert the keywords or meta tags based on the keywords into content pages corresponding to the subscriber.

39. The computer implemented publishing platform of claim 16, further comprising one or more software modules configured to provide a messaging system to users of the publishing platform, the messaging system integrating messages received from a plurality of social network messaging systems.

40. The computer implemented publishing platform of claim 39, wherein the messaging system is configured to provide a send message feature that sends a message to a plurality of destinations, the destinations hosted by a plurality of social network messaging systems.
